(19) United States
(12) Patent Application Publication
(10) Pub. No.: US 2025/0271969 A1
(43) Pub. Date: Aug. 28, 2025

(54) ELECTRONIC DEVICE AND OPERATING METHOD THEREOF

(71) Applicant: SAMSUNG ELECTRONICS CO., LTD., Suwon-si (KR)

(72) Inventors: Donguk KIM, Suwon-si (KR); Sehyun KIM, Suwon-si (KR); Yeonwoo KIM, Suwon-si (KR); Jongin LEE, Suwon-si (KR); Donghwa JEONG, Suwon-si (KR)

(73) Assignee: SAMSUNG ELECTRONICS CO., LTD., Suwon-si (KR)

(21) Appl. No.: 19/021,865

(22) Filed: Jan. 15, 2025

Related U.S. Application Data
(63) Continuation of application No. PCT/KR2024/020823, filed on Dec. 20, 2024.

(30) Foreign Application Priority Data
Feb. 27, 2024 (KR) 10-2024-0028155

(51) Int. Cl. G06F 3/042; G06F 1/16; G06F 3/041; G06V 40/10

(52) U.S. Cl. CPC G06F 3/0426; G06F 1/1673; G06F 3/0418; G06V 40/11

(57) ABSTRACT

Disclosed is an electronic device including a projection component. The electronic device identifies whether a touch sensing device configured to detachably couple to the electronic device is coupled to the electronic device to sense a touch input of a user on a soft keyboard. Based on identification that the touch sensing device is coupled to the electronic device, the electronic device controls the projection component to project a soft keyboard corresponding to a first keyboard layout on a projection plane.

### CROSS-REFERENCE TO RELATED APPLICATION(S)

This application is a continuation application of International Application No. PCT/KR2024/020823, filed on Dec. 20, 2024, which claims priority to Korean Patent Application No. 10-2024-0028155, filed on Feb. 27, 2024, the disclosures of which are incorporated by reference herein in their entireties.

### BACKGROUND

### 1. Field

The disclosure relates to an electronic device and an operating method thereof, and more particularly, to an electronic device including a projection module and an operating method thereof.

### 2. Description of Related Art

With the recent development of mobile communication technology, portable electronic devices, such as smartphones and tablet personal computers (PCs), may be easy to carry and support various functions, such as calls, message transmission and reception, Internet access, and chatting. Such portable electronic devices include a display and a touch panel to receive user input. The touch panel of the portable electronic device allows a user to perform various inputs by touching a soft keyboard on the display.

However, there are limitations in increasing the display size of portable electronic devices. Accordingly, there is a high possibility that various typographical errors may occur when using a soft keyboard of a user, and it may be less efficient in terms of speed and accuracy, compared to using a regular keyboard. In particular, in the case of tablet PCs, a portion of the display is hidden by a soft keyboard.

Furthermore, in order to change a soft keyboard layout or manipulate the configuration of soft keys included in the soft keyboard layout, a user has to manually manipulate settings.

To solve the problems described above, the disclosure provides a method of dynamically configuring a soft keyboard layout most effective for a user according to a user's input method when an electronic device projects a soft keyboard, which allows the user to perform an input more efficiently and conveniently.

### SUMMARY

According to an aspect of the disclosure, there is provided an electronic device including: a projection component; at least one processor including processing circuitry; and memory storing one or more instructions that, when executed by the at least one processor individually or collectively, cause the electronic device to: identify whether a touch sensing device is coupled to the electronic device to sense a touch input of a user on a soft keyboard, wherein the touch sensing device is configured to detachably couple to the electronic device; and based on identification that the touch sensing device is coupled to the electronic device, control the projection component to project a soft keyboard corresponding to a first keyboard layout on a projection plane.

The memory may store the one or more instructions that, when executed by the at least one processor individually or collectively, cause the electronic device further to, based on identification that the touch sensing device is not coupled to the electronic device, control the projection component to project a soft keyboard corresponding to a second keyboard layout on the projection plane.

The memory may store the one or more instructions that, when executed by the at least one processor individually or collectively, cause the electronic device further to, based on identification that the touch sensing device is coupled to the electronic device while projecting the soft keyboard corresponding to the second keyboard layout, control the projection component to change the soft keyboard corresponding to the second keyboard layout to the soft keyboard corresponding to the first keyboard layout and project the soft keyboard corresponding to the first keyboard layout.

The memory may store the one or more instructions that, when executed by the at least one processor individually or collectively, cause the electronic device further to, based on identification that the touch sensing device is separated from the electronic device while projecting the soft keyboard corresponding to the first keyboard layout, control the projection component to change the soft keyboard corresponding to the first keyboard layout to the soft keyboard corresponding to the second keyboard layout and project the soft keyboard corresponding to the second keyboard layout.

The first keyboard layout may be a keyboard layout corresponding to a touch input mode and the second keyboard layout may be a keyboard layout corresponding to a remote input mode.

The memory may store the one or more instructions that, when executed by the at least one processor individually or collectively, cause the electronic device further to: identify that a projection mode of the electronic device to which the touch sensing device is coupled is switched from a floor projection mode to a wall projection mode; and based on identification that the projection mode of the electronic device to which the touch sensing device is coupled is switched to the wall projection mode, control the projection component to change the soft keyboard corresponding to the first keyboard layout to the soft keyboard corresponding to the second keyboard layout and project the soft keyboard corresponding to the second keyboard layout.

The memory may store the one or more instructions that, when executed by the at least one processor individually or collectively, cause the electronic device further to: identify that a projection mode of the electronic device to which the touch sensing device is coupled is switched from a floor projection mode to a wall projection mode; based on identification that the projection mode of the electronic device to which the touch sensing device is attached is switched to the wall projection mode, disable a touch input mode; and control the projection component to project, on the projection plane, a user interface (UI), wherein the UI guides an adjustment of a projection direction or a position of the electronic device to correspond to the wall projection mode or the floor projection mode.

The memory may store the one or more instructions that, when executed by the at least one processor individually or collectively, cause the electronic device further to: based on information collected by the touch sensing device coupled to the electronic device, detect an error of the touch input of the user; and adjust at least one of a size, a spacing, or a position of soft keys included in the soft keyboard corresponding to the first keyboard layout so as to compensate for the detected error of the touch input of the user.

The memory may store the one or more instructions that, when executed by the at least one processor individually or collectively, cause the electronic device further to: obtain image data capturing a touch input activity of the user; obtain information related to a hand of the user by analyzing the image data, wherein the information related to the hand of the user includes at least one of: a number of hands of the user, a position and a direction of the hands of the user, whether the hand of the user is a left hand or a right hand, a spacing between two hands of the user, or a length of a finger included in the hand of the user; and based on the obtained information related to the hand of the user, determine a type of the soft keyboard corresponding to the first keyboard layout; and adjust a size, a spacing, or a position of the soft keys included in the soft keyboard corresponding to the first keyboard layout.

The memory may store the one or more instructions that, when executed by the at least one processor individually or collectively, cause the electronic device further to: based on the hand of the user being identified by analyzing the image data, control the projection component to project the soft keyboard corresponding to the first keyboard layout; and based on the hand of the user not being identified by analyzing the image data, control the projection component to project the soft keyboard corresponding to the second keyboard layout or not to project the soft keyboard.

According to an aspect of the disclosure, there is provided an operating method of an electronic device, including: identifying, whether a touch sensing device is coupled to the electronic device so as to sense a touch input of a user on a soft keyboard, wherein the touch sensing device is configured to detachably couple to the electronic device; and based on identification that the touch sensing device is coupled to the electronic device, controlling, a projection component to project a soft keyboard corresponding to a first keyboard layout on a projection plane.

The method may further include, based on identification that the touch sensing device is not coupled to the electronic device, controlling the projection component to project a soft keyboard corresponding to a second keyboard layout on the projection plane.

The method may further include, based on identification that the touch sensing device is coupled to the electronic device while projecting the soft keyboard corresponding to the second keyboard layout, controlling the projection component to change the soft keyboard corresponding to the second keyboard layout to the soft keyboard corresponding to the first keyboard layout and project the soft keyboard corresponding to the first keyboard layout.

The method may further include, based on identification that the touch sensing device is separated from the electronic device while projecting the soft keyboard corresponding to the first keyboard layout, controlling the projection module to change the soft keyboard corresponding to the first keyboard layout to the soft keyboard corresponding to the second keyboard layout and project the soft keyboard corresponding to the second keyboard layout.

The first keyboard layout may be a keyboard layout corresponding to a touch input mode and the second keyboard layout may be a keyboard layout corresponding to a remote input mode.

The method may further include identifying that the projection mode of the electronic device to which the touch sensing device is coupled is switched from a floor projection mode to a wall projection mode; and based on identification that the projection mode of the electronic device to which the touch sensing device is coupled is switched to the wall projection mode, controlling the projection module to change the soft keyboard corresponding to the first keyboard layout to the soft keyboard corresponding to the second keyboard layout and project the soft keyboard corresponding to the second keyboard layout.

The method may further include, identifying that the projection mode of the electronic device to which the touch sensing device is coupled is switched from a floor projection mode to a wall projection mode; based on identification that the projection mode of the electronic device to which the touch sensing device is coupled is switched to the wall projection mode, disabling a touch input mode; and controlling the projection module to project, on the projection plane, a user interface (UI), wherein the UI guides an adjustment of a projection direction or a position of the electronic device to correspond to the wall projection mode or the floor projection mode.

The method may further include, based on information collected by the touch sensing device coupled to the electronic device, detecting an error of the touch input of the user; and adjusting at least one of a size, a spacing, or a position of soft keys included in the soft keyboard corresponding to the first keyboard layout so as to compensate for the detected error of the touch input of the user.

The method may further include, obtaining image data capturing a touch input activity of the user; obtaining information related to a hand of the user by analyzing the image data, wherein the information related to the hand of the user includes at least one of a number of hands of the user, a position and a direction of the hands of the user, whether the hand of the user is a left hand or a right hand, a spacing between two hands of the user, or a length of a finger included in the hand of the user; based on the obtained information related to the hand of the user, determining a type of the soft keyboard corresponding to the first keyboard layout; and adjusting a size, a spacing, or a position of the soft keys included in the soft keyboard corresponding to the first keyboard layout.

According to an aspect of the disclosure, there is provided a non-transitory computer-readable recording medium having recorded thereon at least one program for causing a computer to implement an operating method including: identifying, whether a touch sensing device is coupled to the electronic device so as to sense a touch input of a user on a soft keyboard, wherein the touch sensing device is configured to detachably couple to the electronic device; and based on identification that the touch sensing device is coupled to the electronic device, controlling, a projection component to project a soft keyboard corresponding to a first keyboard layout on a projection plane.

Other technical features may be easily understood by those of ordinary skill in the art from the accompanying drawings, descriptions, and claims.

### BRIEF DESCRIPTION OF THE DRAWINGS

FIG. 1 illustrates the concept of an electronic device according to an embodiment of the disclosure.

FIGS. 2A and 2B illustrate an example of a coupling method between an electronic device and a touch sensing device according to an embodiment of the disclosure.

FIG. 2C illustrates a method, performed by an electronic device, of receives information about a user's touch position from a touch sensing device, according to an embodiment of the disclosure.

FIG. 3A illustrates an example of a first keyboard layout corresponding to a touch input mode according to an embodiment of the disclosure.

FIG. 3B illustrates an example of a second keyboard layout corresponding to a remote input mode according to an embodiment of the disclosure.

FIG. 4 is a flowchart of an operating method of an electronic device according to an embodiment of the disclosure.

FIG. 5 illustrates the operation of the electronic device when the touch sensing device is coupled to the electronic device, according to an embodiment of the disclosure.

FIG. 6 illustrates the operation of the electronic device when the touch sensing device is separated from the electronic device, according to an embodiment of the disclosure.

FIG. 7A illustrates a floor projection mode of the electronic device according to an embodiment of the disclosure.

FIG. 7B illustrates a wall projection mode of the electronic device according to an embodiment of the disclosure.

FIG. 8 illustrates the operation of the electronic device when the projection mode of the electronic device is switched from the floor projection mode to the wall projection mode, according to an embodiment of the disclosure.

FIG. 9 is illustrates the operation of the electronic device when the projection mode of the electronic device is switched from the floor projection mode to the wall projection mode, according to an embodiment of the disclosure.

FIGS. 10A and 10B illustrate examples of the operation of the electronic device when the electronic device detects an error of touch input, according to an embodiment of the disclosure.

FIGS. 11A to 11E illustrate examples of types of soft keyboard layouts based on information related to a user's hands, according to an embodiment of the disclosure.

FIG. 12 is a flowchart of an operating method of an electronic device according to an embodiment of the disclosure.

FIG. 13A illustrates the operation of the electronic device when the electronic device identifies a user's hands, according to an embodiment of the disclosure.

FIG. 13B illustrates the operation of the electronic device when the electronic device does not identify a user's hands, according to an embodiment of the disclosure.

FIG. 14 is a block diagram of a processor according to an embodiment of the disclosure.

FIG. 15 is a block diagram of an electronic device according to an embodiment of the disclosure.

FIG. 16 is a detailed block diagram of the electronic device according to an embodiment of the disclosure.

### DETAILED DESCRIPTION

As for the terms as used in the disclosure, common terms that are currently widely used are selected as much as possible while taking into account the functions in the disclosure. However, these terms may refer to various other terms depending on the intention of those of ordinary skill in the art, precedents, the emergence of new technology, and the like. Also, in a specific case, there are also terms arbitrarily selected by the applicant. In this case, the meaning of the terms will be described in detail in the description of the embodiment of the disclosure. Therefore, the terms as used herein should be defined based on the meaning of the terms and the description throughout the disclosure rather than simply the names of the terms.

The terms as used in the disclosure are only used to describe a specific embodiment of the disclosure, and are not intended to limit the disclosure.

The singular forms as used herein are intended to include the plural forms as well unless the context clearly indicates otherwise. All terms including technical or scientific terms as used herein have the same meaning as commonly understood by those of ordinary skill in the art.

Throughout the disclosure, the expression “a portion includes a certain element” means that a portion further includes other elements rather than excludes other elements unless otherwise stated. Also, the terms such as “unit” and “module” described in the specification mean units that process at least one function or operation, and may be implemented as hardware, software, or a combination of hardware and software.

Also, each of the elements to be described below may additionally perform, in addition to the main function thereof, some or all of the functions that other elements are responsible for, and some of the main functions that the respective elements are responsible for may be dedicated by other elements.

The expression “configured to” as used herein may be used interchangeably with, for example, “suitable for,” “having the capacity to,” “designed to,” “adapted to,” “made to,” or “capable of” depending on a situation.

The term “configured to” may not necessarily mean only “specifically designed to” in hardware. Instead, in some situations, the expression “a system configured to” may mean that the system is “capable of . . . ” with other devices or components.

Also, when one element is referred to as “connected” or “coupled” to another element, the one element may be directly connected or coupled to the other element, but it will be understood that the elements may be connected or coupled to each other via an intervening element therebetween unless the context clearly indicates otherwise. In addition, it will be understood that when a portion is referred to as being “connected to” another portion, it may be “directly connected to” the other portion or “electrically connected to” the other portion with intervening portions therebetween.

The term “the” and similar demonstratives as used in the present specification, particularly in the patent claims, may refer to both the singular and the plural. Operations constituting methods may be performed in any suitable order unless otherwise indicated herein or otherwise clearly contradicted by context, and are not necessarily limited to the stated order. The disclosure is not limited by the order of operations described herein.

The expressions “in an embodiment of the disclosure” appearing in various places in the present specification do not necessarily all refer to the same embodiment.

Some embodiments of the disclosure may be represented by functional block configurations and various processes. Some or all of such functional blocks may be implemented in any number of hardware and/or software configurations that perform specific functions. For example, the functional blocks of the disclosure may be implemented by one or more microprocessors or may be implemented by circuitry configurations for certain functions. In addition, for example, the functional blocks of the disclosure may be implemented in various programming or scripting languages. The functional blocks may be implemented as algorithms to be executed by one or more processors. In addition, the disclosure may employ conventional technologies for electronic environment setting, signal processing, and/or data processing.

In order to clearly explain the disclosure, parts irrelevant to the description are omitted in the drawings, and similar reference numerals are assigned to similar parts throughout the specification. Also, reference numerals used in the drawings are only for describing the drawings, and different reference numerals used in different drawings are not intended to indicate different elements. In addition, connecting lines or connecting members illustrated in the drawings are intended to represent functional connections and/or physical or circuitry connections. In an actual device, connecting lines or connecting members illustrated in the drawings may represent a variety of alternative or additional functional, physical, or circuitry connections.

In describing embodiments of the disclosure, when the detailed description of the relevant known functions or configurations is determined to unnecessarily obscure the gist of the disclosure, the detailed description thereof may be omitted herein. Throughout the disclosure, the expression “at least one of a, b or c” indicates only a, only b, only c, both a and b, both a and c, both b and c, all of a, b, and c, or variations thereof. Also, numbers (e.g., first, second, etc.) used in the description of the specification are merely identification symbols for distinguishing one element from another.

Hereinafter, an embodiment of the disclosure will be described in detail with reference to the accompanying drawings, so that those of ordinary skill in the art may easily carry out the disclosure. However, the disclosure may be implemented in various different forms and is not limited to the embodiments of the disclosure described herein.

The term “user” as used herein refers to a person who controls the functions or operations of an electronic device by using a control device, and may include a consumer, an evaluator, an viewer, an administrator, or an installer.

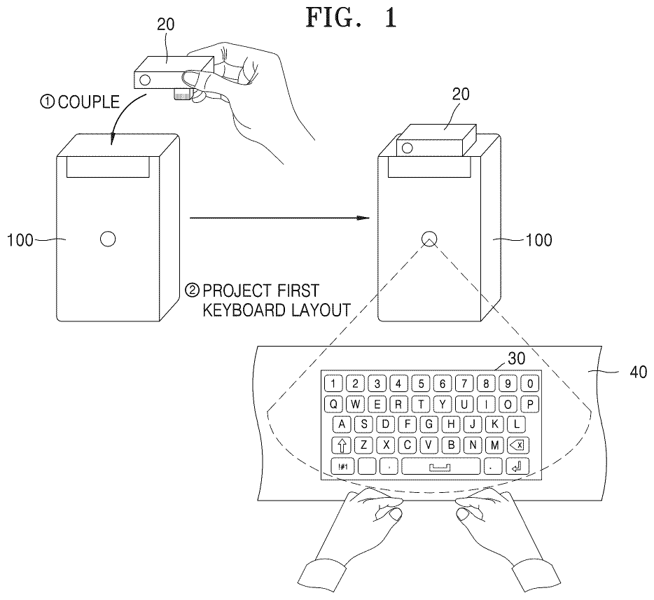

FIG. 1 illustrates the concept of an electronic device 100 according to an embodiment of the disclosure.

Referring to FIG. 1, the electronic device 100 according to an embodiment of the disclosure may identify whether a touch sensing device 20 is coupled to the electronic device 100.

The electronic device 100 according to an embodiment of the disclosure may be detachably coupled to the touch sensing device 20.

The touch sensing device 20 according to an embodiment of the disclosure is an external device that is distinguishable from the electronic device 100 and may refer to a device configured to sense a soft keyboard touch input of the user. For example, the touch sensing device 20 may include an intra radio (IR) camera and an IR laser, but the disclosure is not limited thereto.

The electronic device 100 may obtain, from the touch sensing device 20 through data pins or wireless communication technology (e.g., near field communication (NFC), Bluetooth, etc.), a variety of information about a touch input of the user (e.g., touch position information, touch count information, etc.) on a soft keyboard layout corresponding to a projected first keyboard layout 30.

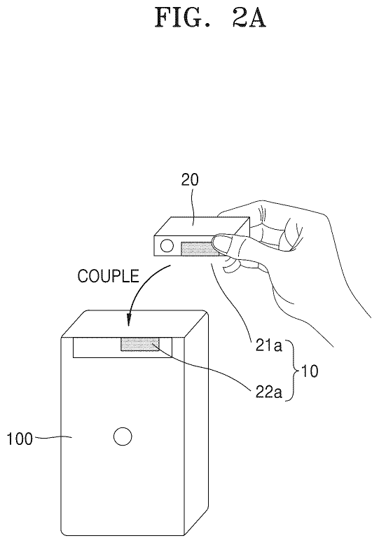

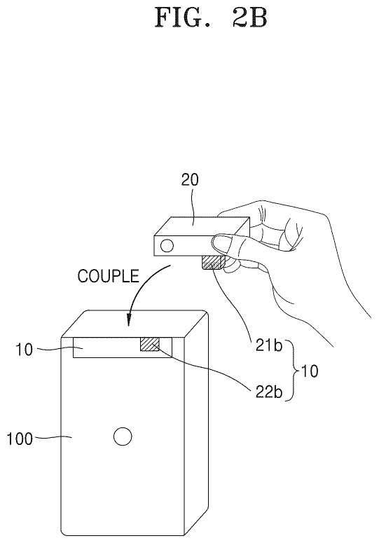

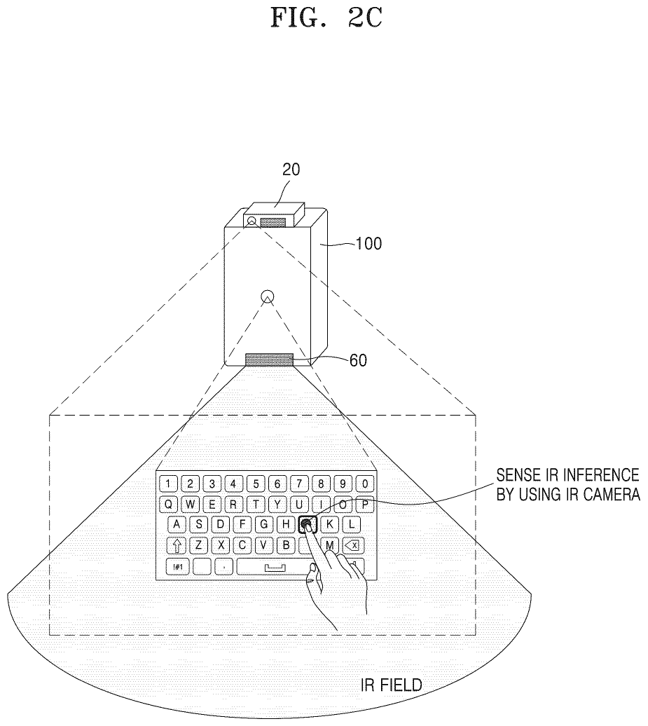

In an embodiment of the disclosure, the coupling between the electronic device 100 and the touch sensing device 20 may mean that the electronic device 100 and the touch sensing device 20 are detachably coupled to each other. For example, the coupling between the electronic device 100 and the touch sensing device 20 may mean a state in which the electronic device 100 and the touch sensing device 20 may be physically attached to each other, but may be separable from each other at any time. This is described in detail with reference to FIGS. 2A and 2B.

When a user wants to perform touch input through a soft keyboard by using a user's body (e.g., hands) without using a remote control, the touch sensing device 20 may be coupled to the electronic device 100.

When the electronic device 100 according to an embodiment of the disclosure identifies that the touch sensing device 20 is coupled to the electronic device 100, the electronic device 100 may control a projection module to project a soft keyboard corresponding to the first keyboard layout 30 on a projection plane 40.

In an embodiment of the disclosure, the first keyboard layout 30 may refer to a keyboard layout of a soft keyboard corresponding to a touch input mode of the electronic device 100. The first keyboard layout 30 may refer to a keyboard layout configuration of a soft keyboard that is more advantageous/suitable/optimized for touch input using a user's body (e.g., hands) (e.g. a touch input mode) than for input using a remote control (e.g., a remote input mode). For example, the first keyboard layout 30 may include a QWERTY keyboard layout, but the disclosure is not limited thereto.

When the electronic device 100 identifies that the touch sensing device 20 is coupled to the electronic device 100, the electronic device 100 may predict/decide/determine that a user will perform input using his/her body (e.g., hand) (e.g., a touch input mode) rather than input using a remote control (e.g., a remote input mode). Accordingly, the electronic device 100 may determine the soft keyboard layout as the first keyboard layout 30 corresponding to the touch input mode and may control the projection module to automatically project the first keyboard layout 30 on the projection plane.

This may solve the inconvenience of, when the user wants to perform touch input through the soft keyboard by using the electronic device 100, having to perform additional settings so as to change the keyboard layout of the soft keyboard layout to be advantageous/suitable for the touch input.

According to an embodiment of the disclosure, the electronic device 100 provides a method of dynamically configuring a soft keyboard layout most effective for a user according to a user's input method, allowing the user to perform input more efficiently and conveniently.

However, effects to be achieved by the disclosure are not limited to those described above, and other effects that are not mentioned herein will be clearly understood from the following description by those of ordinary skill in the art.

FIGS. 2A and 2B are diagrams for describing an example of a coupling method between an electronic device 100 and a touch sensing device 20 according to an embodiment of the disclosure.

Referring to FIGS. 2A and 2B, the electronic device 100 according to an embodiment of the disclosure may be detachably coupled to the touch sensing device 20.

The touch sensing device 20 according to an embodiment of the disclosure is an external device that is distinguishable from the electronic device 100 and may refer to a device configured to sense a user's soft keyboard touch input. For example, the touch sensing device 20 may include an IR camera, but the disclosure is not limited thereto.

In an embodiment of the disclosure, the coupling between the electronic device 100 and the touch sensing device 20 may mean that the electronic device 100 and the touch sensing device 20 are detachably coupled to each other. For example, the coupling between the electronic device 100 and the touch sensing device 20 may mean a state in which the electronic device 100 and the touch sensing device 20 may be physically attached to each other, but may be separable from each other at any time.

The electronic device 100 and the touch sensing device 20 according to an embodiment of the disclosure may include a coupling means 10 for detachably coupling the electronic device 100 and the touch sensing device 20 to each other. A user may physically attach the touch sensing device 20 to the electronic device 100 by using the coupling means 10 or may physically separate the touch sensing device 20 from the electronic device 100 by using the coupling means 10.

The coupling means 10 according to an embodiment of the disclosure may refer to any means that is capable of physically detachably coupling the electronic device 100 and the touch sensing device 20 to each other. For example, the coupling means 10 may include a magnetic connector or a universal serial bus (USB) port, but the disclosure is not limited thereto.

Referring to FIG. 2A, the coupling means 10 according to an embodiment of the disclosure may include magnetic connectors 21a and 22a. The electronic device 100 according to an embodiment of the disclosure may include the magnetic connector 22a as the coupling means 10 for detachable coupling to the touch sensing device 20. When the user brings the touch sensing device 20 close to the electronic device 100, an attractive force may act between the magnetic connectors 21a and 22a, and thus, the electronic device 100 and the touch sensing device 20 may be physically coupled to each other. When the user pulls the touch sensing device 20 in a direction opposite to the electronic device 100, the electronic device 100 and the touch sensing device 20 may be physically separated from each other.

When the electronic device 100 receives a certain signal indicating that the touch sensing device 20 is coupled to the electronic device 100 through a sensor, an electrical circuitry, or a data pin, which is included in the magnetic connectors 21a and 22a, or wireless communication technology (e.g., NFC, Bluetooth, etc.) integrated in the magnetic connectors 21a and 22a, the electronic device 100 may identify that the touch sensing device 20 is coupled to the electronic device 100 and may obtain, from the touch sensing device 20, a variety of information about a user's touch input (e.g., touch position information, touch count information, etc.) on the soft keyboard layout corresponding to the first keyboard layout 30.

When the electronic device 100 according to an embodiment of the disclosure identifies that the touch sensing device 20 is coupled to the electronic device 100 through the magnetic connector 22a, the electronic device 100 may control the projection module to project the soft keyboard corresponding to the first keyboard layout 30 on the projection plane 40.

Referring to FIG. 2B, the coupling means 10 according to an embodiment of the disclosure may include USB ports 21b and 22b. The electronic device 100 according to an embodiment of the disclosure may include the USB port 22b as the coupling means 10 for detachable coupling to the touch sensing device 20. When the user inserts the USB port 21b of the touch sensing device 20 into the USB port 22b of the electronic device 100, the electronic device 100 and the touch sensing device 20 may be physically coupled to each other. When the user pulls the touch sensing device 20 in a direction opposite to the electronic device 100, the electronic device 100 and the touch sensing device 20 may be physically separated from each other.

When the electronic device 100 receives a certain signal indicating that the touch sensing device 20 is coupled to the electronic device 100 through a sensor, an electrical circuitry, or a data pin, which is included in the USB ports 21b and 22b, or wireless communication technology (e.g., NFC, Bluetooth, etc.) integrated in the USB ports 21b and 22b, the electronic device 100 may identify that the touch sensing device 20 is coupled to the electronic device 100 and may obtain, from the touch sensing device 20, a variety of information about a user's touch input (e.g., touch position information, touch count information, etc.) on the soft keyboard layout corresponding to the first keyboard layout 30.

When the electronic device 100 according to an embodiment of the disclosure identifies that the touch sensing device 20 is coupled to the electronic device 100 through the USB port 22b, the electronic device 100 may control the projection module to project the soft keyboard corresponding to the first keyboard layout 30 on the projection plane 40.

FIG. 2C is a diagram for describing a method, performed by the electronic device 100, of receives information about a user's touch position from the touch sensing device 20, according to an embodiment of the disclosure.

Referring to FIG. 20, in an embodiment of the disclosure, the electronic device 100 may include an IR light emitter 60. When the touch sensing device 20 is coupled to the electronic device 100, the IR light emitter 60 of the electronic device 100 may generate an IR field on the same plane as the bottom surface of the electronic device 100.

The touch sensing device 20 may use an IR camera to determine which position the user touches on the soft keyboard, that is, the position of the user's touch input on the soft keyboard.

When the user touches the projected soft keyboard, the touch sensing device 20 may use the IR camera to sense IR interference occurring in the IR field. Accordingly, the touch sensing device 20 may determine which position the user touches on the soft keyboard.

The electronic device 100 may receive information about the user's touch position, including a result of determining the user's touch input position on the soft keyboard, from the touch sensing device 20 through the data pin or wireless communication technology.

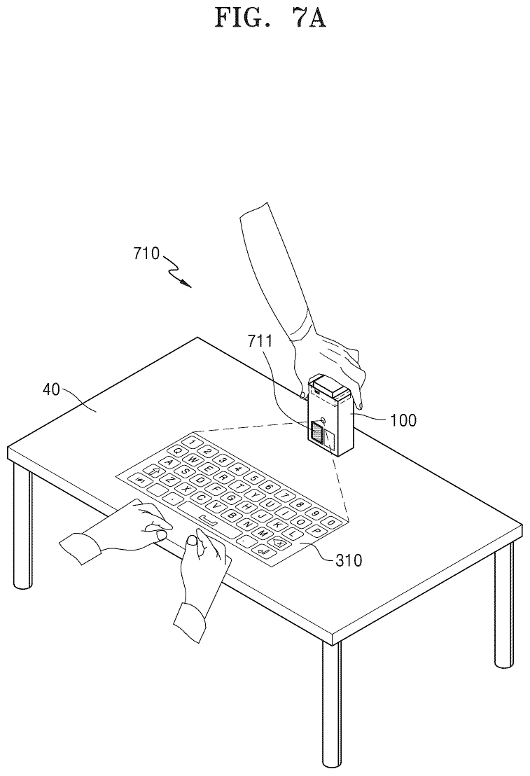

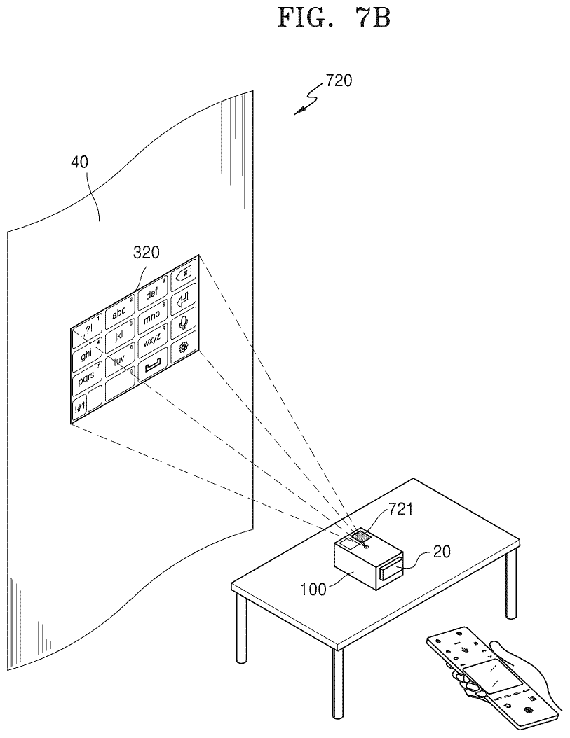

Accordingly, when the electronic device 100 is in a floor projection mode 710, the projection plane on which the soft keyboard is projected and the plane on which the IR field is generated (the bottom surface of the electronic device 100) almost coincide with each other, which is suitable for the user to perform touch input. On the other hand, when the electronic device 100 is in a wall projection mode 720, the projection plane on which the soft keyboard is projected and the plane on which the IR field is generated (the bottom surface of the electronic device 100) are spaced apart from each other, which is not suitable for the user to perform touch input but is suitable for the user to perform remote input. This is described in detail with reference to FIGS. 7A and 7B.

According to an embodiment of the disclosure, the electronic device 100 may be detachably coupled to the touch sensing device 20 through a variety of coupling means. Once the touch sensing device 20 is coupled to the electronic device 100, the electronic device 100 automatically projects the soft keyboard layout corresponding to the touch input mode. Accordingly, when the user wants to perform the soft keyboard touch input, the user may automatically perform touch input without additional settings by simply attaching the touch sensing device 20 to the electronic device 100.

However, effects to be achieved by the disclosure are not limited to those described above, and other effects that are not mentioned herein will be clearly understood from the following description by those of ordinary skill in the art.

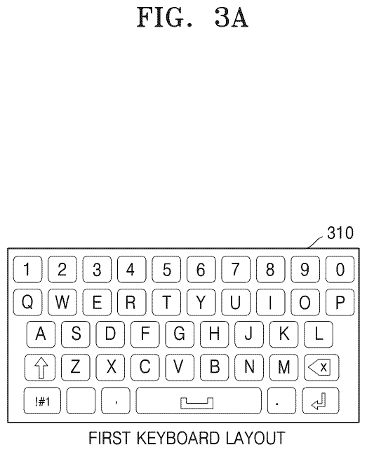

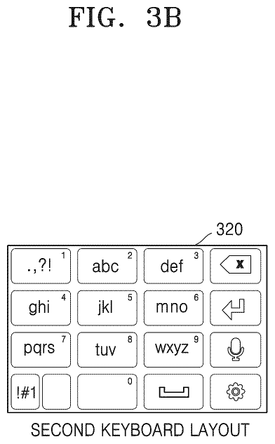

FIG. 3A is a diagram for describing an example of a first keyboard layout 310 corresponding to a touch input mode according to an embodiment of the disclosure. The first keyboard layout 310 of FIG. 3A may refer to the first keyboard layout 30 of FIG. 1.

Referring to FIG. 3A, the first keyboard layout 310 according to an embodiment of the disclosure may refer to a keyboard layout of the soft keyboard corresponding to the touch input mode of the electronic device 100.

The first keyboard layout 310 may refer to a keyboard layout configuration of a soft keyboard that is more advantageous/suitable/optimized for touch input using a user's body (e.g., hands) (e.g. a touch input mode) than for input using a remote control (e.g., a remote input mode).

For example, the first keyboard layout 310 may include one of a QWERTY layout, a DVORAK layout, a COLEMAK layout, a QWERTZ layout, an AZERTY layout, a Hangul 2-beol type layout, a Hangul 3-beol type layout, or a JIS layout, but the disclosure is not limited thereto.

The example of FIG. 3A only illustrates an example of the first keyboard layout 310. The first keyboard layout 310 may include various soft keys to be advantageous/suitable for the user's touch input. The soft keys included in the first keyboard layout 310 may have various layouts to be advantageous/suitable for the user's touch input.

FIG. 3B is a diagram for describing an example of a second keyboard layout 320 corresponding to a remote input mode according to an embodiment of the disclosure.

Referring to FIG. 3B, the second keyboard layout 320 according to an embodiment of the disclosure may refer to a keyboard layout of the soft keyboard corresponding to the remote input mode of the electronic device 100.

The second keyboard layout 320 may refer to a keyboard layout configuration of a soft keyboard that is more advantageous/suitable/optimized for touch input using a remote control (e.g., a remote input mode) than for touch input using a user's body (e.g., hands) (e.g., a touch input mode).

For example, the second keyboard layout 320 may include one of a Moaki layout, a Cheonjiin layout, a Naratgeul layout, a Sky Hangul layout, or a 10-key layout with an alphabet added.

The example of FIG. 3B only illustrates an example of the second keyboard layout 320. The second keyboard layout 320 may include various soft keys to be advantageous/suitable for the input using a remote control. The soft keys included in the second keyboard layout 320 may have various layouts to be advantageous/suitable for the input using a remote control.

In an embodiment of the disclosure, the electronic device 100 may project the soft keyboard corresponding to the first keyboard layout 310 in a smaller size than the soft keyboard corresponding to the second keyboard layout 320 by taking into account the general hand size of users.

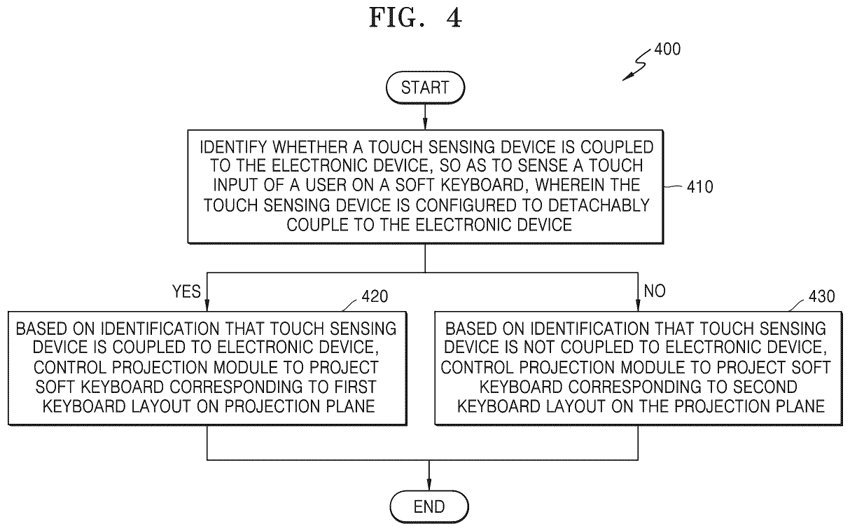

FIG. 4 is a flowchart for describing an operating method 400 of the electronic device 100 according to an embodiment of the disclosure.

Referring to FIG. 4, in operation 410, the electronic device 100 according to an embodiment of the disclosure may identify whether the touch sensing device 20 capable of being detachably coupled to the electronic device is coupled to the electronic device 100 so as to sense a user's touch input on the soft keyboard. At this time, the coupling between the touch sensing device 20 and the electronic device 100 may refer to detachable coupling between the touch sensing device 20 and the electronic device 100. The electronic device 100 may include a coupling means 10 for detachable coupling to the touch sensing device 20.

In an embodiment of the disclosure, the electronic device 100 may identify through a magnetic sensor or a contact sensor that the touch sensing device 20 is coupled thereto. In an embodiment of the disclosure, the electronic device 100 may identify that the touch sensing device 20 is coupled thereto by sensing that an electrical circuitry is completed and a specific electrical signal flows therethrough when the touch sensing device 20 is coupled to the electronic device 100. In an embodiment of the disclosure, the electronic device 100 may identify that the touch sensing device 20 is coupled thereto by exchanging state information or a specific signal with the touch sensing device 20 through wireless communication (e.g., NFC, Bluetooth, etc.).

In operation 420, when the electronic device 100 according to an embodiment of the disclosure identifies that the touch sensing device 20 is coupled to the electronic device 100, the electronic device 100 may control the projection module to project the soft keyboard corresponding to the first keyboard layout 310 on the projection plane 40.

In an embodiment of the disclosure, the electronic device 100 may control the projection module not to project the soft keyboard until the touch sensing device 20 is coupled thereto and to project the soft keyboard corresponding to the first keyboard layout 310 on the projection plane 40 when the electronic device 100 identifies/senses/detects that the touch sensing device 20 is coupled thereto.

In an embodiment of the disclosure, the first keyboard layout 310 may refer to a keyboard layout of a soft keyboard corresponding to the touch input mode of the electronic device 100. The first keyboard layout 310 may refer to a keyboard layout configuration of a soft keyboard that is more advantageous/suitable/optimized for touch input using a user's body (e.g., hands) (e.g. a touch input mode) than for input using a remote control (e.g., a remote input mode). For example, the first keyboard layout 310 may include one of a QWERTY layout, a DVORAK layout, a COLEMAK layout, a QWERTZ layout, an AZERTY layout, a Hangul 2-beol type layout, a Hangul 3-beol type layout, or a JIS layout, but the disclosure is not limited thereto.

In operation 430, when the electronic device 100 according to an embodiment of the disclosure identifies that the touch sensing device 20 is not coupled to the electronic device 100, the electronic device 100 may control the projection module to project the soft keyboard corresponding to the second keyboard layout 320 on the projection plane 40.

In an embodiment of the disclosure, when the touch sensing device 20 is not coupled to the electronic device 100, the electronic device 100 may predict/determine that the user uses the electronic device 100 in a remote input mode and may control the projection module to project the soft keyboard corresponding to the second keyboard layout 320 on the projection plane 40.

In an embodiment of the disclosure, the second keyboard layout 320 may refer to a keyboard layout of the soft keyboard corresponding to the remote input mode of the electronic device 100. The second keyboard layout 320 may refer to a keyboard layout configuration of a soft keyboard that is more advantageous/suitable/optimized for touch input using a remote control (e.g., a remote input mode) than for touch input using a user's body (e.g., hands) (e.g., a touch input mode). For example, the second keyboard layout 320 may include one of a Moaki layout, a Cheonjiin layout, a Naratgeul layout, a Sky Hangul layout, or a 10-key layout with an alphabet added.

In an embodiment of the disclosure, when the electronic device 100 receives a signal indicating a request to display the soft keyboard while projecting content (e.g., when the user selects a search function, etc.), the electronic device 100 may control the projection module to project the soft keyboard corresponding to the first keyboard layout 310 of operation 420 or the soft keyboard corresponding to the second keyboard layout 320 of operation 430 at the lower end of the layout.

In an embodiment of the disclosure, when the electronic device 100 receives a signal indicating a request to display the soft keyboard while projecting content (e.g., when the user selects a search function, etc.), the electronic device 100 may control the projection module to stop projecting content and project the soft keyboard corresponding to the first keyboard layout 310 of operation 420 or the soft keyboard corresponding to the second keyboard layout 320 of operation 430.

According to an embodiment of the disclosure, the electronic device 100 may allow the user to perform input more efficiently and conveniently by providing a method of dynamically configuring a soft keyboard layout most effective for a user according to a user's input method when projecting content.

However, effects to be achieved by the disclosure are not limited to those described above, and other effects that are not mentioned herein will be clearly understood from the following description by those of ordinary skill in the art.

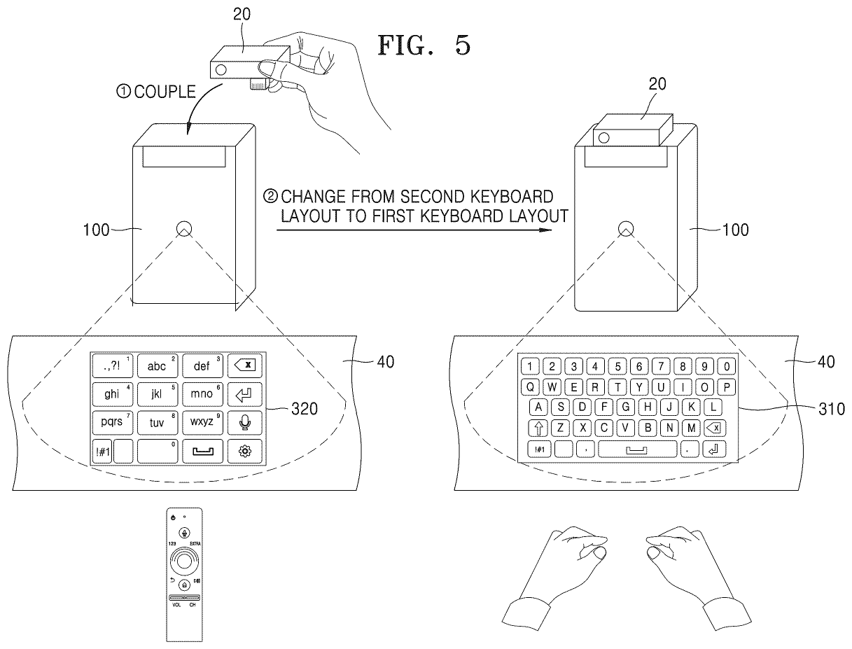

FIG. 5 is a diagram for describing the operation of the electronic device 100 when the touch sensing device 20 is coupled to the electronic device 100, according to an embodiment of the disclosure.

Referring to FIG. 5, in an embodiment of the disclosure, when the touch sensing device 20 is coupled to the electronic device 100 while the soft keyboard corresponding to the second keyboard layout 320 is projected, the electronic device 100 may change the keyboard layout of the soft keyboard layout from the second keyboard layout 320 to the first keyboard layout 310.

In an embodiment of the disclosure, the electronic device 100 may control the projection module to project the soft keyboard layout corresponding to the second keyboard layout 320 until the touch sensing device 20 is coupled to the electronic device 100, to change the keyboard layout of the soft keyboard layout to the first keyboard layout 310 when the electronic device 100 identifies/senses/detects that the touch sensing device 20 is coupled to the electronic device 100, and to project the soft keyboard corresponding to the first keyboard layout 310 on the projection plane 40.

For example, a situation may occur in which the user uses the electronic device 100 in the remote input mode to perform soft keyboard input by using the remote control and then significantly increases the input speed and input accuracy. At this time, the user may couple the touch sensing device 20 to the electronic device 100 without additional settings. The electronic device 100 may project the soft keyboard corresponding to the second keyboard layout 320, may identify/sense/detect the moment the user couples the touch sensing device 20 to the electronic device 100, may automatically change to the soft keyboard corresponding to the first keyboard layout 310, and may project the soft keyboard on the projection plane 40. The user may perform touch input through the soft keyboard corresponding to the first keyboard layout 310 projected by the electronic device 100 without additional settings, and the input speed and input accuracy may be significantly increased.

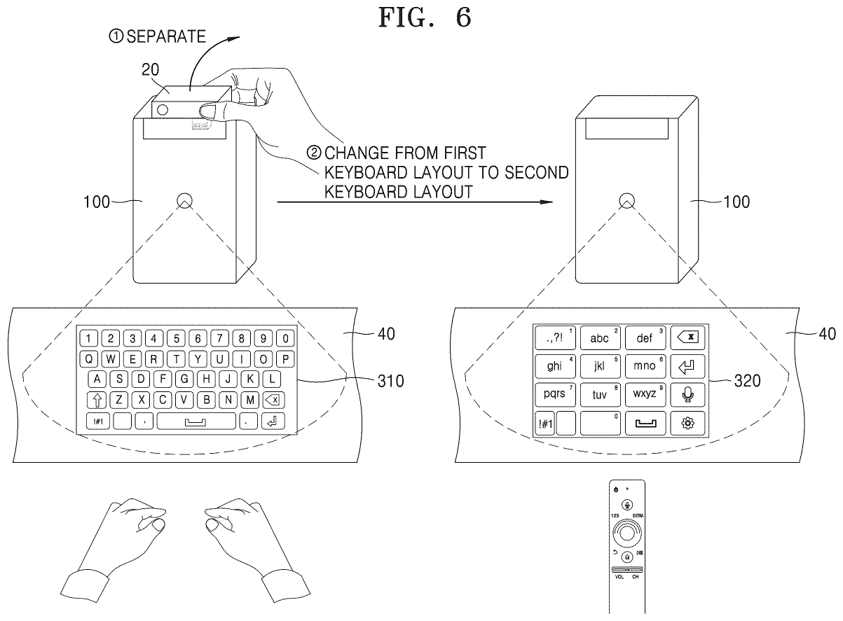

FIG. 6 is a diagram for describing the operation of the electronic device 100 when the touch sensing device 20 is separated from the electronic device 100, according to an embodiment of the disclosure.

Referring to FIG. 6, in an embodiment of the disclosure, the electronic device 100 may identify whether the touch sensing device 20 is separated from the electronic device 100, while projecting the soft keyboard corresponding to the first keyboard layout 310. When the touch sensing device 20 is separated from the electronic device 100, the electronic device 100 may change the keyboard layout of the soft keyboard from the first keyboard layout 310 to the second keyboard layout 320.

In an embodiment of the disclosure, the electronic device 100 may control the projection module to project the soft keyboard corresponding to the first keyboard layout 310 while the touch sensing device 20 is coupled to the electronic device 100, to change the keyboard layout of the soft keyboard to the second keyboard layout 320 when the electronic device 100 identifies/senses/detects that the touch sensing device 20 is separated from the electronic device 100, and to project the soft keyboard corresponding to the second keyboard layout 320 on the projection plane 40.

For example, a situation may occur in which the user uses the electronic device 100 in the touch input mode to perform soft keyboard touch input with his/her hands and then wants to perform soft keyboard input by using the remote control. At this time, the user may separate the touch sensing device 20 from the electronic device 100 without additional settings. The electronic device 100 may project the soft keyboard layout corresponding to the first keyboard layout 310, may identify/sense/detect the moment the user separates the touch sensing device 20 from the electronic device 100, may automatically change to the soft keyboard corresponding to the second keyboard layout 320, and may project the soft keyboard on the projection plane 40. The user may perform input by using the remote control through the soft keyboard corresponding to the second keyboard layout 320 projected by the electronic device 100 without additional settings.

According to an embodiment of the disclosure, the electronic device 100 may allow the user to perform input more efficiently and conveniently by providing a method of dynamically configuring a soft keyboard layout most effective for a user according to a user's input method when projecting content.

However, effects to be achieved by the disclosure are not limited to those described above, and other effects that are not mentioned herein will be clearly understood from the following description by those of ordinary skill in the art.

FIGS. 7A and 7B are diagrams for describing the projection mode of the electronic device 100 according to an embodiment of the disclosure. Referring to FIGS. 7A and 7B, the electronic device 100 according to an embodiment of the disclosure may be used in a floor projection mode as illustrated in FIG. 7A or in a wall projection mode as illustrated in FIG. 7B.

FIG. 7A is a diagram for describing the floor projection mode of the electronic device 100 according to an embodiment of the disclosure.

Referring to FIG. 7A, a case where the projection module of the electronic device 100 according to an embodiment of the disclosure faces the front side of the electronic device 100 may be referred to as the floor projection mode.

In an embodiment of the disclosure, the electronic device 100 may use a motion sensor or an acceleration sensor to identify that the projection module that projects the soft keyboard faces the front side of the electronic device 100. When the electronic device 100 identifies that the projection module faces the front side, the electronic device 100 may recognize/determine that the projection mode of the electronic device 100 is the floor projection mode 710.

For example, the user may adjust the projection module to face the front side by standing or laying down the electronic device 100. In this case, the electronic device 100 may recognize/determine that the projection mode of the electronic device 100 is the floor projection mode 710.

In an embodiment of the disclosure, the electronic device 100 may recognize/determine that the projection mode of the electronic device 100 is the floor projection mode 710, through the operation in which the user places the electronic device 100 on a table. When the user places the electronic device 100 on the table so that the projection module of the electronic device 100 faces the front side, the electronic device 100 may recognize/determine that the projection mode of the electronic device 100 is the floor projection mode 710.

In an embodiment of the disclosure, the electronic device 100 may recognize/determine that the projection mode of the electronic device 100 is the floor projection mode 710, through the operation in which the user pushes a floor projection mode button 711 of the electronic device 100. When the user pushes the floor projection mode button 711 of the electronic device 100, the sensor connected to the floor projection mode button 711 may sense the pushing, may generate an electrical signal or a signal indicating a state change, and may recognize/determine that the projection mode of the electronic device 100 is the floor projection mode 710.

In an embodiment of the disclosure, when the electronic device 100 identifies that the touch sensing device 20 is coupled thereto and recognizes/determines that the projection mode of the electronic device 100 is the floor projection mode 710, the electronic device 100 may the soft keyboard corresponding to the first keyboard layout 310 in response to the floor projection mode 710.

In an embodiment of the disclosure, when the projection mode of the electronic device 100 is the floor projection mode, the projection plane is the bottom surface of the electronic device 100 and the IR field is also generated on the bottom surface of the electronic device 100. In this case, the generated IR field and the bottom surface of the electronic device 100 almost coincide with each other. Accordingly, when the user touches the soft keyboard corresponding to the projected first keyboard layout 310, the touch sensing device 20 coupled to the electronic device 100 may determine which position the user touches on the soft keyboard by using the IR camera to sense that IR interference occurs in the generated IR field. The electronic device 100 may receive information about the user's touch position from the touch sensing device 20 through the data pin or wireless communication technology. Accordingly, the user may efficiently perform touch input through the soft keyboard corresponding to the first keyboard layout 310.

The user may use the soft keyboard by simply placing the projection module of the electronic device 100 to face the front side, by simply placing the electronic device 100 on the table, or by simply pushing the floor projection mode button 711, without a cumbersome process of adjusting the projection plane of the electronic device 100.

FIG. 7B is a diagram for describing the wall projection mode of the electronic device 100 according to an embodiment of the disclosure.

Referring to FIG. 7B, a case where the projection module of the electronic device 100 according to an embodiment of the disclosure faces the ceiling may be referred to as the wall projection mode.

In an embodiment of the disclosure, the electronic device 100 may use a motion sensor or an acceleration sensor to identify that the projection module that projects the soft keyboard faces the ceiling. When the electronic device 100 identifies that the projection module faces the ceiling, the electronic device 100 may recognize/determine that the projection mode of the electronic device 100 is the wall projection mode 720. For example, the user may adjust the projection module to face the ceiling by standing or laying down the electronic device 100. In this case, the electronic device 100 may recognize/determine that the projection mode of the electronic device 100 is the wall projection mode 720.

In an embodiment of the disclosure, the electronic device 100 may recognize/determine that the projection mode of the electronic device 100 is the wall projection mode 720, through the operation in which the user attaches the electronic device 100 to the wall. When the user attaches the electronic device 100 to the wall so that the projection module of the electronic device 100 faces the ceiling, the electronic device 100 may recognize/determine that the projection mode of the electronic device 100 is the wall projection mode 720.

In an embodiment of the disclosure, the electronic device 100 may recognize/determine that the projection mode of the electronic device 100 is the wall projection mode 720, through the operation in which the user pushes a wall projection mode button 721 of the electronic device 100. When the user pushes the wall projection mode button 721 of the electronic device 100, the sensor connected to the wall projection mode button 721 may sense the pushing, may generate an electrical signal or a signal indicating a state change, and may recognize/determine that the projection mode of the electronic device 100 is the wall projection mode 720.

In an embodiment of the disclosure, even when the electronic device 100 identifies that the touch sensing device 20 is coupled thereto, when the electronic device 100 recognizes/determines that the projection mode of the electronic device 100 is the wall projection mode 720, the electronic device 100 may the soft keyboard corresponding to the second keyboard layout 320 in response to the wall projection mode 720.

In an embodiment of the disclosure, when the projection mode of the electronic device 100 is the wall projection mode, the projection plane is the wall and the IR field is also generated on the bottom surface of the electronic device 100. In this case, the generated IR field and the projection plane of the electronic device 100 do not coincide with each other and may be spaced apart from each other. The expression “spaced apart” may mean a state in which two surfaces are not completely in contact with or coincident with each other and there is some space or spacing. In the wall projection mode, even when the user touches the projected soft keyboard, no IR interference occurs in the IR field. Accordingly, the touch sensing device 20 coupled to the electronic device 100 may not be suitable for sensing the user's touch. In this case, the electronic device 100 may project the soft keyboard of the second keyboard layout 320 corresponding to the remote input mode, and accordingly, the user may efficiently perform remote input by using a remote input device such as a remote control through the soft keyboard corresponding to the second keyboard layout 320.

The user may use the soft keyboard by simply placing the projection module of the electronic device 100 to face the wall, by simply placing the electronic device 100 on the wall, or by simply pushing the wall projection mode button 721, without a cumbersome process of adjusting the projection plane of the electronic device 100.

According to an embodiment of the disclosure, the electronic device 100 may allow the user to perform input more efficiently and conveniently by providing the method of dynamically configuring the soft keyboard layout most effective for the user according to the user's input method and the projection mode of the electronic device 100 when projecting the soft keyboard.

However, effects to be achieved by the disclosure are not limited to those described above, and other effects that are not mentioned herein will be clearly understood from the following description by those of ordinary skill in the art.

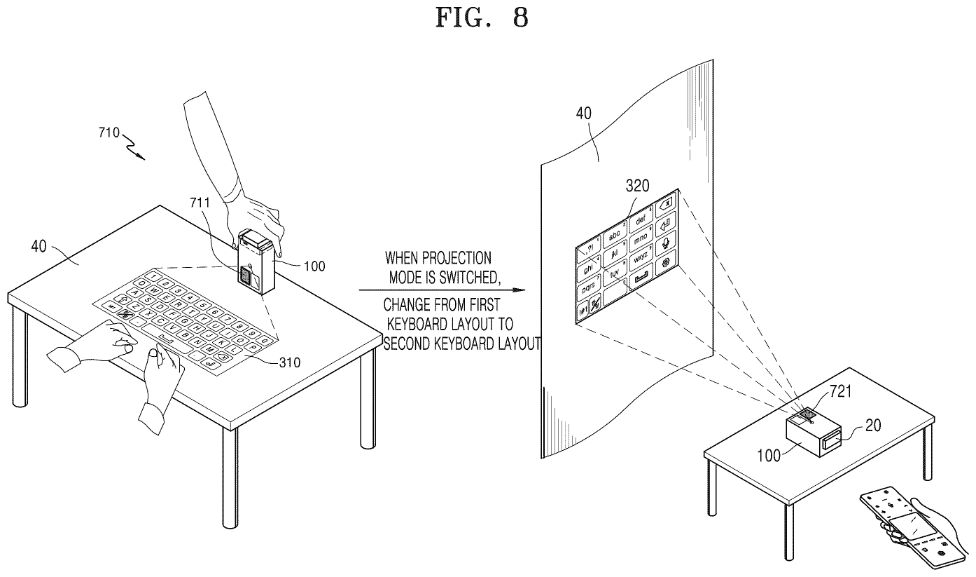

FIG. 8 is a diagram for describing the operation of the electronic device 100 when the projection mode of the electronic device 100 is switched from the floor projection mode 710 to the wall projection mode 720, according to an embodiment of the disclosure.

Referring to FIG. 8, the electronic device 100 according to an embodiment of the disclosure may identify that the projection mode of the electronic device 100 is switched from the floor projection mode 710 to the wall projection mode 720.

In an embodiment of the disclosure, the electronic device 100 may use a motion sensor or an acceleration sensor to identify that the projection module that projects the soft keyboard is adjusted from facing the front side to facing the ceiling. Accordingly, the electronic device 100 may identify that the projection mode of the electronic device 100 is switched from the floor projection mode 710 to the wall projection mode 720.

In an embodiment of the disclosure, the electronic device 100 may identify that the projection mode of the electronic device 100 is switched from the floor projection mode 710 to the wall projection mode 720, through the operation in which the user attaches the electronic device 100 to the wall. When the user attaches the electronic device 100 to the wall so that the projection module of the electronic device 100 is adjusted to face the ceiling, the electronic device 100 may recognize/determine that the projection mode of the electronic device 100 is switched to the wall projection mode 720.

When the projection mode of the electronic device 100 is switched from the floor projection mode 710 to the wall projection mode 720, the electronic device 100 according to an embodiment of the disclosure may change the soft keyboard layout to the second keyboard layout 320.

In an embodiment of the disclosure, when the projection mode of the electronic device 100 is the wall projection mode, the projection plane is the wall and the IR field is generated on the bottom surface of the electronic device 100. In this case, the generated IR field and the projection plane of the electronic device 100 do not coincide with each other and may be spaced apart from each other. The expression “spaced apart” may mean a state in which two surfaces are not completely in contact with or coincident with each other and there is some space or spacing. Accordingly, the wall projection mode may not be suitable for the touch sensing device 20 coupled to the electronic device 100 to sense the user's touch.

Accordingly, when the projection mode of the electronic device 100 is switched from the floor projection mode 710 to the wall projection mode 720, the electronic device 100 may determine to automatically change the soft keyboard of the first keyboard layout 310 corresponding to the touch input mode to the soft keyboard of the second keyboard layout 320 corresponding to the remote input mode and may automatically project the soft keyboard corresponding to the second keyboard layout 320.

Accordingly, when the user wants to perform the remote input while performing the touch input, the user may efficiently perform input by using the remote control through the soft keyboard corresponding to the second keyboard layout 320 automatically projected by the electronic device 100 by simply attaching the electronic device 100 to the wall, laying down the electronic device 100, or standing up the electronic device 100 without additional settings.

In an embodiment of the disclosure, while projecting the soft keyboard corresponding to the first keyboard layout 310 in response to the floor projection mode 710 in a state in which the touch sensing device 20 is coupled to the electronic device 100, the electronic device 100 may project the soft keyboard corresponding to the second keyboard layout 320 in response to the wall projection mode 720 when the electronic device 100 recognizes/detects/identifies that the projection mode of the electronic device 100 is switched to the wall projection mode 720, through the operation in which the user attaches the electronic device 100 to the wall or lays down or stands up the electronic device 100. At this time, the electronic device 100 may project the soft keyboard corresponding to the second keyboard layout 320 in response to the wall projection mode 720, regardless of whether the touch sensing device 20 is coupled to the electronic device 100.

For example, a situation may occur in which the user performs soft keyboard touch input with his/her hands by using the electronic device 100 on the table in the touch input mode and then wants to perform soft keyboard input with the remote control by attaching the electronic device 100 to the wall, laying down the electronic device 100, or standing up the electronic device 100 so as to perform another task. At this time, by simply attaching the electronic device 100 to the wall, laying down the electronic device 100, or standing up the electronic device 100 without additional settings, the user may perform input by using the remote control through the soft keyboard corresponding to the second keyboard layout 320 projected by the electronic device 100.

According to an embodiment of the disclosure, the electronic device 100 may allow the user to perform input more efficiently and conveniently by providing the method of dynamically configuring the soft keyboard layout most effective for the user according to the user's input method and the projection mode of the electronic device 100 when projecting the soft keyboard.

However, effects to be achieved by the disclosure are not limited to those described above, and other effects that are not mentioned herein will be clearly understood from the following description by those of ordinary skill in the art.

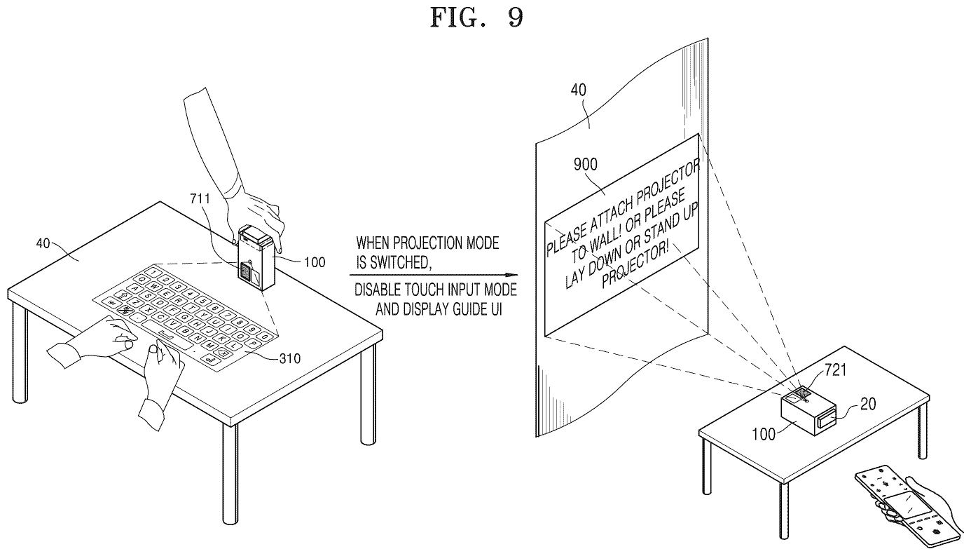

FIG. 9 is a diagram for describing the operation of the electronic device 100 when the projection mode of the electronic device 100 is switched from the floor projection mode 710 to the wall projection mode 720, according to an embodiment of the disclosure.

Referring to FIG. 9, the electronic device 100 according to an embodiment of the disclosure may identify that the projection mode of the electronic device 100 is switched from the floor projection mode 710 to the wall projection mode 720.

The electronic device 100 may use a motion sensor or an acceleration sensor to identify that the projection module that projects the soft keyboard is adjusted from facing the front side to facing the ceiling. Accordingly, the electronic device 100 may identify that the projection mode of the electronic device 100 is switched from the floor projection mode 710 to the wall projection mode 720. In an embodiment of the disclosure, the electronic device 100 may identify that the projection mode of the electronic device 100 is switched from the floor projection mode 710 to the wall projection mode 720, through the operation in which the user pushes the wall projection mode button 721. When the user pushes the wall projection mode button 721 of the electronic device 100, the sensor connected to the wall projection mode button 721 may sense the pushing, may generate an electrical signal or a signal indicating a state change, and may identify that the projection mode of the electronic device 100 is switched to the wall projection mode 720.

When the projection mode of the electronic device 100 is switched to the wall projection mode 720, the electronic device 100 according to an embodiment of the disclosure may disable the touch input mode.

When the projection mode of the electronic device 100 is switched to the wall projection mode 720, the electronic device 100 according to an embodiment of the disclosure may control the projection module to project, on the projection plane 40, a user interface (UI) 900 that guides an adjustment of the projection direction of the electronic device 100 or the position of the electronic device 100 to correspond to the wall projection mode 720, or guides an adjustment of the projection direction of the electronic device 100 or the position of the electronic device 100 to correspond to the floor projection mode 710. Accordingly, when the user wants to continue to use the electronic device 100 in the floor projection mode 710 according to a message included in the UI 900, the user may adjust the projection module of the electronic device 100 to face the front side, or when the user wants to use the electronic device 100 in the wall projection mode 720, the user may adjust the projection module of the electronic device 100 to face the ceiling.

In an embodiment of the disclosure, when the projection mode of the electronic device 100 is the wall projection mode, the projection plane is the wall and the IR field is generated on the bottom surface of the electronic device 100. In this case, the generated IR field and the projection plane of the electronic device 100 do not coincide with each other and may be spaced apart from each other. The expression “spaced apart” may mean a state in which two surfaces are not completely in contact with or coincident with each other and there is some space or spacing. Accordingly, the wall projection mode may not be suitable for the touch sensing device 20 coupled to the electronic device 100 to sense the user's touch.

Accordingly, when the projection mode of the electronic device 100 is switched from the floor projection mode 710 to the wall projection mode 720, the electronic device 100 may disable the touch input mode and then display a UI that guides the user to adjust the position and direction of the electronic device 100 to be suitable for the wall projection mode 720 or the floor projection mode 710 according to the user's intention.

As an example illustrated in FIG. 9, the UI 900 may include messages such as <Please attach the projector to the wall!> or <Please lay down or stand up the projector!>. In an embodiment of the disclosure, the electronic device 100 may output a voice guidance sound such as <Please attach the projector to the wall!> or <Please lay down or stand up the projector!>, while projecting the UI 900 including the message such as <Please attach the projector to the wall!> or <Please lay down or stand up the projector!>.

The user may perform an action to attach the electronic device 100 to the wall, lay down the electronic device 100, or stand up the electronic device 100 so that the projection module of the electronic device 100 faces the ceiling, according to the guidance message included in the UI 900. Accordingly, as described with reference to FIG. 8, the electronic device 100 may identify that the projection mode of the electronic device 100 is switched to the wall projection mode 720 and may project the soft keyboard layout corresponding to the second keyboard layout 320. Descriptions redundant with those provided with reference to FIG. 8 are replaced with those described with reference to FIG. 8 and are omitted herein.

The user may perform an action to lay down the electronic device 100 or stand up the electronic device 100 so that the projection module of the electronic device 100 faces the front side, according to the guidance message included in the UI 900. Accordingly, as described with reference to FIG. 7A, the electronic device 100 may identify that the projection mode of the electronic device 100 is switched to the floor projection mode 710 and may project the soft keyboard layout corresponding to the first keyboard layout 310. Descriptions redundant with those provided with reference to FIG. 7A are replaced with those described with reference to FIG. 7A and are omitted herein.

According to an embodiment of the disclosure, the electronic device 100 may allow the user to perform input more efficiently or conveniently by providing a guide UI for dynamically configuring a soft keyboard layout most effective for the user when the projection mode of the electronic device 100 is changed.

However, effects to be achieved by the disclosure are not limited to those described above, and other effects that are not mentioned herein will be clearly understood from the following description by those of ordinary skill in the art.

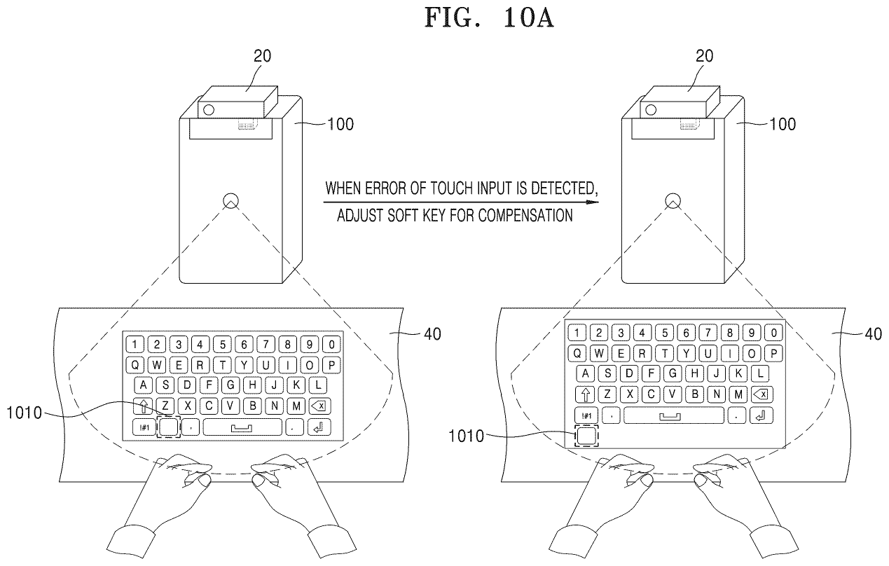

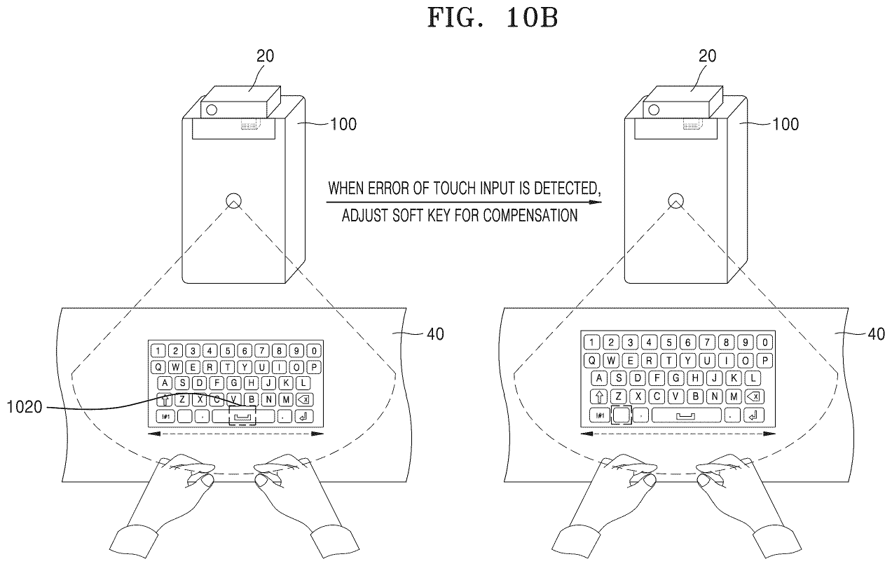

FIGS. 10A and 10B are diagrams for describing examples of the operation of the electronic device 100 when the electronic device 100 detects an error of touch input, according to an embodiment of the disclosure.

Referring to FIGS. 10A and 10B, the electronic device 100 according to an embodiment of the disclosure may detect an error of user's touch input based on information collected by the touch sensing device 20 coupled to the electronic device 100.

The touch sensing device 20 may sense the user's touch input on the soft keyboard layout corresponding to the first keyboard layout 310 projected by the electronic device 100, and may collect information about the user's touch count.

In an embodiment of the disclosure, the electronic device 100 may obtain information about the user's touch position and information about the user's touch count from the touch sensing device 20. The electronic device 100 may detect the error of user's touch input based on the obtained information about the user's touch position and the obtained information about the user's touch count.

In an embodiment of the disclosure, the electronic device 100 may set events corresponding to the error of touch input as a policy in advance. The event corresponding to the error of touch input may include various events. For example, the event may include a case where a specific soft key included in the soft keyboard (e.g., Korean/English toggle key or backspace, etc.) is pushed several times (e.g., 5 times) or more in succession during a certain period of time, but the disclosure is not limited thereto.

In an embodiment of the disclosure, when the event corresponding to the error of touch input occurs, the electronic device 100 may determine the event as the error of touch input and detect the error, based on the information about the user's touch position and the information about the user's touch count, which are obtained from the touch sensing device 20.

In order to compensate for the detected error of user's touch input, the electronic device 100 according to an embodiment of the disclosure may adjust at least one of the size, the spacing, or the position of soft keys included in the soft keyboard layout corresponding to the first keyboard layout 310.

For example, in the example of FIG. 10A, when the Korean/English toggle key 1010 included in the soft keyboard corresponding to the first keyboard layout 310 is pushed 5 times or more, the electronic device 100 may determine the event as the error of the touch input and detect the error based on the information about the user's touch position and the information about the user's touch count, which are obtained from the touch sensing device 20. As in the example of FIG. 10A, in order to compensate for the detected error of the user's touch input, the electronic device 100 may adjust the position of the Korean/English toggle key 1010 included in the soft keyboard layout corresponding to the first keyboard layout 310 so that the position of the Korean/English toggle key 1010 is changed downward. Accordingly, the electronic device 100 may prevent an error of the touch input from occurring due to interference of the Korean/English toggle key 1010 with other soft keys when the user subsequently perform soft keyboard touch input.

For example, in the example of FIG. 10B, when the backspace key 1020 included in the soft keyboard corresponding to the first keyboard layout 310 is pushed 5 times or more, the electronic device 100 may determine the event as the error of the touch input and detect the error based on the information about the user's touch position and the information about the user's touch count, which are obtained from the touch sensing device 20. As in the example of FIG. 10B, in order to compensate for the detected error of the user's touch input, the electronic device 100 may adjust the size and spacing of soft keys included in the soft keyboard layout corresponding to the first keyboard layout 310 so that the size and spacing of the soft keys are increased. Accordingly, the electronic device 100 may prevent the error of touch input from occurring due to interference of the backspace key 1020 with other soft keys when the user subsequently perform soft keyboard touch input.

According to an embodiment of the disclosure, the electronic device 100 may allow the user to perform input more efficiently and conveniently by providing a method of detecting error of the user's touch input and dynamically adjusting soft keys included in the soft keyboard layout so as to compensate for the detected error of user's touch input.

However, effects to be achieved by the disclosure are not limited to those described above, and other effects that are not mentioned herein will be clearly understood from the following description by those of ordinary skill in the art.

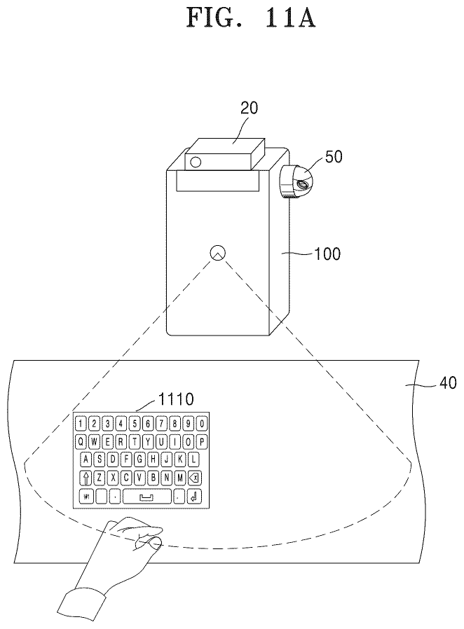

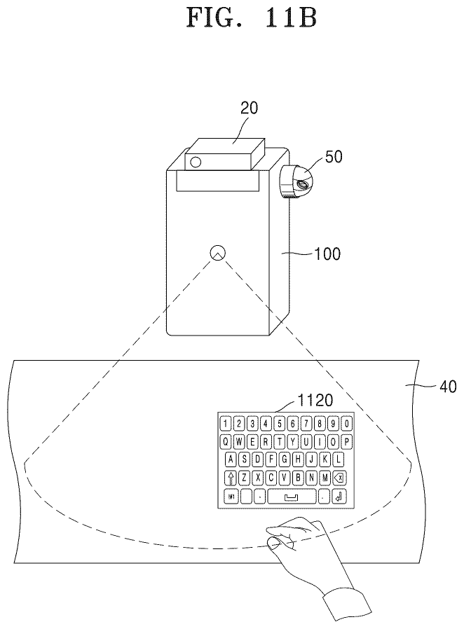

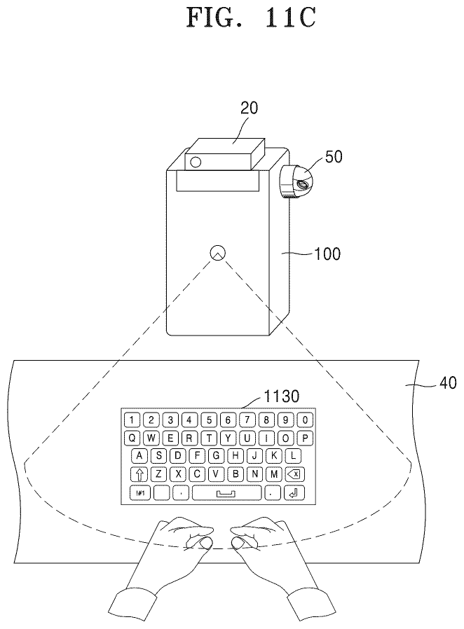

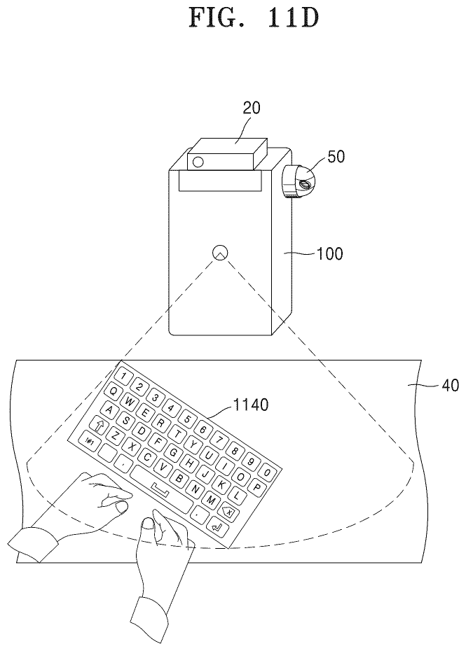

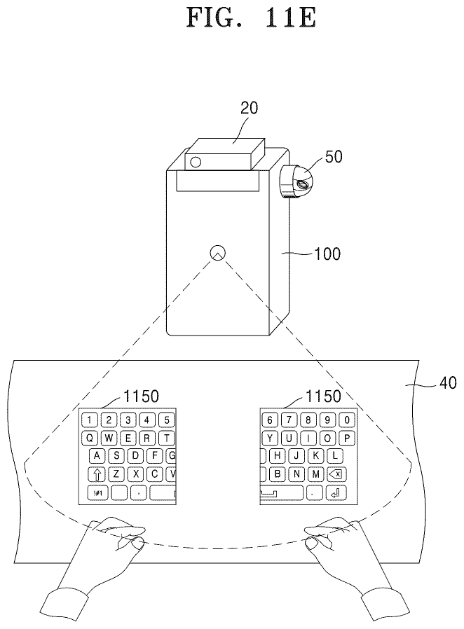

FIGS. 11A to 11E are diagrams for describing examples of types of soft keyboard layouts based on information related to a user's hands, according to an embodiment of the disclosure.

Referring to FIGS. 11A to 11E, the electronic device 100 according to an embodiment of the disclosure may receive, from a camera sensor 50, image data of a user's touch input situation. The camera sensor 50 may be embedded into the electronic device 100 or may be connected to the electronic device 100 through wireless/wired communication as an external device that distinguishes from the electronic device 100. The camera sensor 50 may include an RGB camera, but the disclosure is not limited thereto.

The electronic device 100 according to an embodiment of the disclosure may obtain information related to the user's hands by analyzing the received image data. In an embodiment of the disclosure, the information related to the user's hands may include at least one of the number of the user's hands, the position and direction of the user's hands, whether the user's hand is a left hand or a right hand, the spacing between the user's hands, or the length of the finger included in the user's hand.

The electronic device 100 according to an embodiment of the disclosure may determine the type of soft keyboard corresponding to the first keyboard layout 310 based on the obtained information related to the user's hands, and may adjust the size, the spacing, or the position of soft keys included in the soft keyboard corresponding to the first keyboard layout 310.

In an embodiment of the disclosure, the type of soft keyboard corresponding to the first keyboard layout 310 may include a left-handed mode, a right-handed mode, a two-handed mode, and a split mode. This is described in detail with reference to FIGS. 11A to 11E.

FIG. 11A illustrates an example of the left-handed mode layout 1110 in the type of the soft keyboard corresponding to the first keyboard layout 310. In an embodiment of the disclosure, the electronic device 100 may analyze the image data received from the camera sensor 50. When the electronic device 100 detects that the number of hands is 1 and the user's hand is the left hand, the electronic device 100 may project the left-handed mode layout 1110. The left-handed mode layout 1110 may refer to a soft keyboard layout that allows the user to efficiently input data with only one left hand. For example, the electronic device 100 may project the left-handed mode layout 1110 by reducing the size and spacing of soft keys included in the soft keyboard corresponding to the first keyboard layout 310 so as to be suitable for the length of the fingers included in the user's left hand and positioning the soft keys so as to be closer to the left hand.

FIG. 11B illustrates an example of a right-handed mode layout 1120 in the type of soft keyboard corresponding to the first keyboard layout 310. In an embodiment of the disclosure, the electronic device 100 may analyze the image data received from the camera sensor 50. When the electronic device 100 detects that the number of hands is 1 and the user's hand is the right hand, the electronic device 100 may project the right-handed mode layout 1120. The right-handed mode layout 1120 may refer to a soft keyboard layout that allows the user to efficiently input data with only one right hand. For example, the electronic device 100 may project the right-handed mode layout 1120 by reducing the size and spacing of soft keys included in the soft keyboard corresponding to the first keyboard layout 310 so as to be suitable for the length of the fingers included in the user's right hand and positioning the soft keys so as to be closer to the right hand.

FIG. 11B illustrates an example of a two-handed mode layout 1130 in the type of soft keyboard corresponding to the first keyboard layout 310. In an embodiment of the disclosure, the electronic device 100 may analyze the image data received from the camera sensor 50. When the electronic device 100 detects that the number of hands is 2, the electronic device 100 may project the two-handed mode layout 1130. The two-handed mode layout 1130 may refer to a soft keyboard layout that allows the user to efficiently input data with the user's two hands. For example, by adjusting the size and spacing of the soft keys included in the soft keyboard corresponding to the first keyboard layout 310 so as to be suitable for the length of the fingers included in the user's two hands, the electronic device 100 may project the two-handed mode layout 1130 by positioning the soft keys included in the soft keyboard corresponding to the first keyboard layout 310 so as to correspond to the positions and directions of the user's both hands, as in example 1140 of FIG. 11D.

FIG. 11E illustrates an example of a split mode layout 1150 in the type of soft keyboard corresponding to the first keyboard layout 310. In an embodiment of the disclosure, the electronic device 100 may detect the spacing between the user's right and left hands by analyzing image data received from the camera sensor 50. When the electronic device 100 determines that the spacing between the user's right and left hands is greater than or equal to a defined spacing, the electronic device 100 may project the split mode layout 1150. The split mode layout 1150 may be a layout configured by splitting soft keys to be input by the user's left hand and soft keys to be input by the user's right hand among the soft keys included in the soft keyboard corresponding to the first keyboard layout 310. For example, the electronic device 100 may project the split mode layout 1150 by positioning soft keys to be input by the user's left hand so as to be closer to the user's left hand and positioning soft keys to be input by the user's right hand so as to be closer to the user's right hand.

According to an embodiment of the disclosure, the electronic device 100 may allow the user to perform input more efficiently and conveniently by providing a method of dynamically configuring a soft keyboard layout most effective for a user based on information related to the user's hands.

However, effects to be achieved by the disclosure are not limited to those described above, and other effects that are not mentioned herein will be clearly understood from the following description by those of ordinary skill in the art.

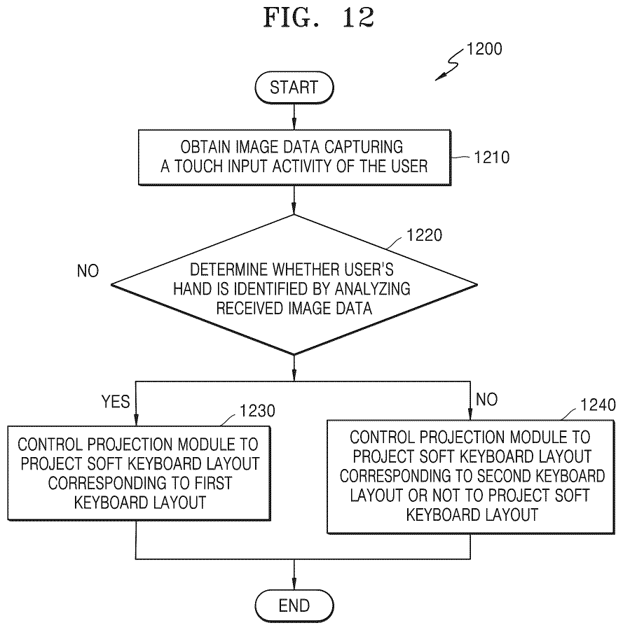

FIG. 12 is a flowchart for describing an operating method 1200 of the electronic device 100 according to an embodiment of the disclosure.

Referring to FIG. 12, in operation 1210, the electronic device 100 according to an embodiment of the disclosure may receive, from the camera sensor 50, image data of a user's touch input situation.

In operation 1220, the electronic device 100 according to an embodiment of the disclosure may determine whether the user's hands are identified by analyzing the received image data.

In operation 1230, when the user's hands are identified, the electronic device 100 according to an embodiment of the disclosure may control the projection module to project the soft keyboard corresponding to the first keyboard layout 310 on the projection plane 40.

When the user's hands are identified, the electronic device 100 may predict/decide/determine that the user will perform input using his/her body (e.g., hands) (e.g. a touch input mode) rather than input using a remote control (e.g., a remote input mode). Accordingly, the electronic device 100 may determine the soft keyboard layout as the first keyboard layout 30 corresponding to the touch input mode and may control the projection module to automatically project the soft keyboard corresponding to the first keyboard layout 30 on the projection plane.

This may solve the inconvenience of, when the user wants to perform touch input through the soft keyboard by using the electronic device 100, having to perform additional settings so as to change the keyboard layout of the soft keyboard to be advantageous/suitable for the touch input.

In operation 1240, when the user's hands are not identified, the electronic device 100 according to an embodiment of the disclosure may control the projection module to project the soft keyboard corresponding to the second keyboard layout 320 on the projection plane 40. Alternatively, when the user's hands are not identified, the electronic device 100 according to an embodiment of the disclosure may control the projection module not to project the soft keyboard.

When the user's hands are not identified, the electronic device 100 may predict/decide/determine that the user will use the electronic device 100 in remote input mode rather than input using his/her body (e.g., hands) (e.g., the touch input mode) and may control the projection module to project the soft keyboard corresponding to the second keyboard layout 320 on the projection plane 40.

Accordingly, when the user wants to perform remote input through the soft keyboard by using the electronic device 100, the inconvenience of having to perform additional settings so as to change the keyboard layout of the soft keyboard to be advantageous/suitable for remote input may be resolved.

Alternatively, the electronic device 100 may repeat an operation of projecting the soft keyboard corresponding to the first keyboard layout 310 when the user's hands are identified as in operation 1230, not projecting the soft keyboard when the user's hands disappear and are not identified, and projecting the soft keyboard corresponding to the first keyboard layout 310 when the user's hands are identified again.

According to an embodiment of the disclosure, the electronic device 100 may allow the user to perform input more efficiently and conveniently by providing a method of dynamically configuring a soft keyboard layout most effective for a user according to a user's input method when projecting content.

However, effects to be achieved by the disclosure are not limited to those described above, and other effects that are not mentioned herein will be clearly understood from the following description by those of ordinary skill in the art.

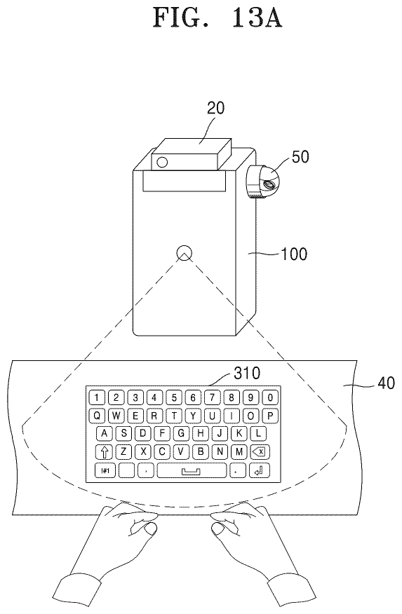

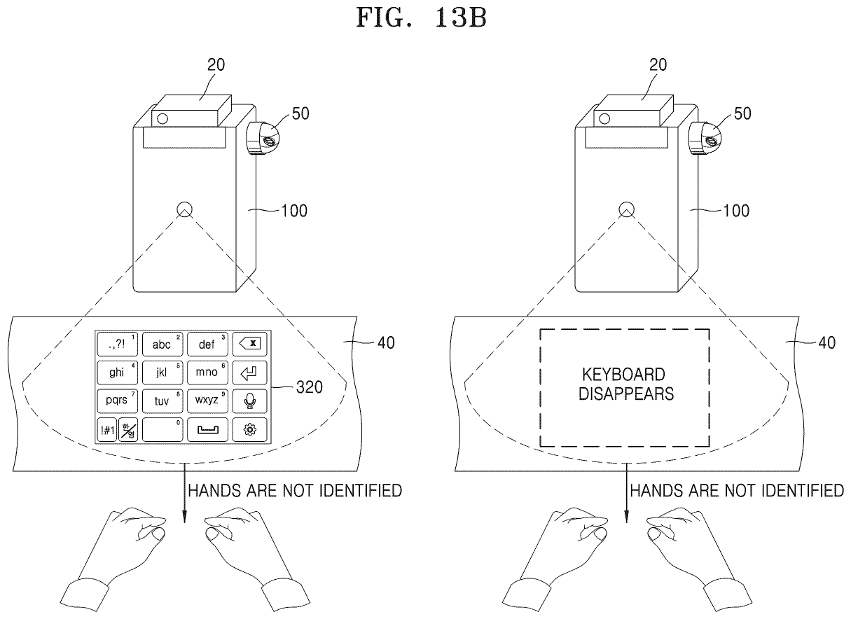

FIG. 13A illustrates an example of operation when the electronic device 100 identifies the user's hands as described in operation 1230, and FIG. 13B illustrates an example of operation when the electronic device 100 does not identify the user's hands as described in operation 1240.

FIG. 13A is a diagram for describing the operation of the electronic device 100 when the electronic device 100 identifies a user's hands, according to an embodiment of the disclosure. Descriptions redundant with those provided with reference to FIG. 12 are replaced with those described with reference to FIG. 12 and are omitted herein.

Referring to FIG. 13A, when the user's hands are identified, the electronic device 100 according to an embodiment of the disclosure may control the projection module to project the soft keyboard corresponding to the first keyboard layout 310 on the projection plane 40.

FIG. 13B is a diagram for describing the operation of the electronic device 100 when the electronic device 100 does not identify a user's hands, according to an embodiment of the disclosure. Descriptions redundant with those provided with reference to FIG. 12 are replaced with those described with reference to FIG. 12 and are omitted herein.

Referring to FIG. 13B, when the user's hands are not identified, the electronic device 100 according to an embodiment of the disclosure may control the projection module to project the soft keyboard corresponding to the second keyboard layout 320 on the projection plane 40. Alternatively, when the user's hands are not identified, the electronic device 100 according to an embodiment of the disclosure may control the projection module not to project the soft keyboard.

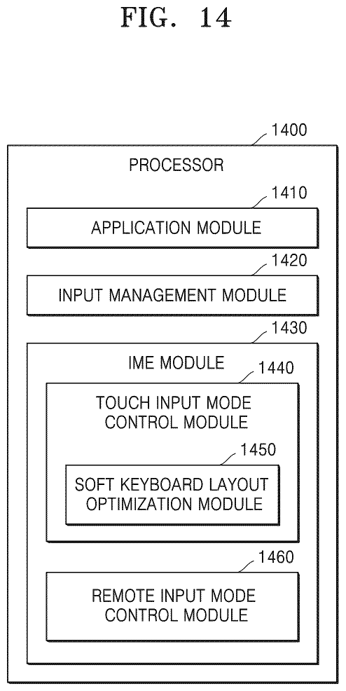

FIG. 14 is a block diagram of a processor 1400 according to an embodiment of the disclosure.

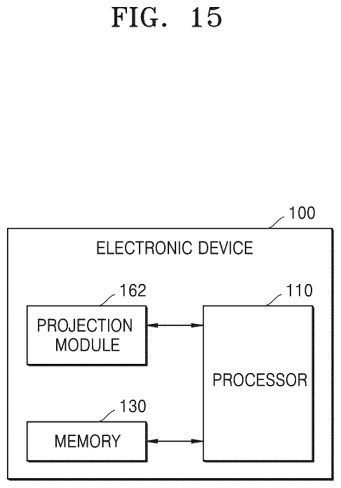

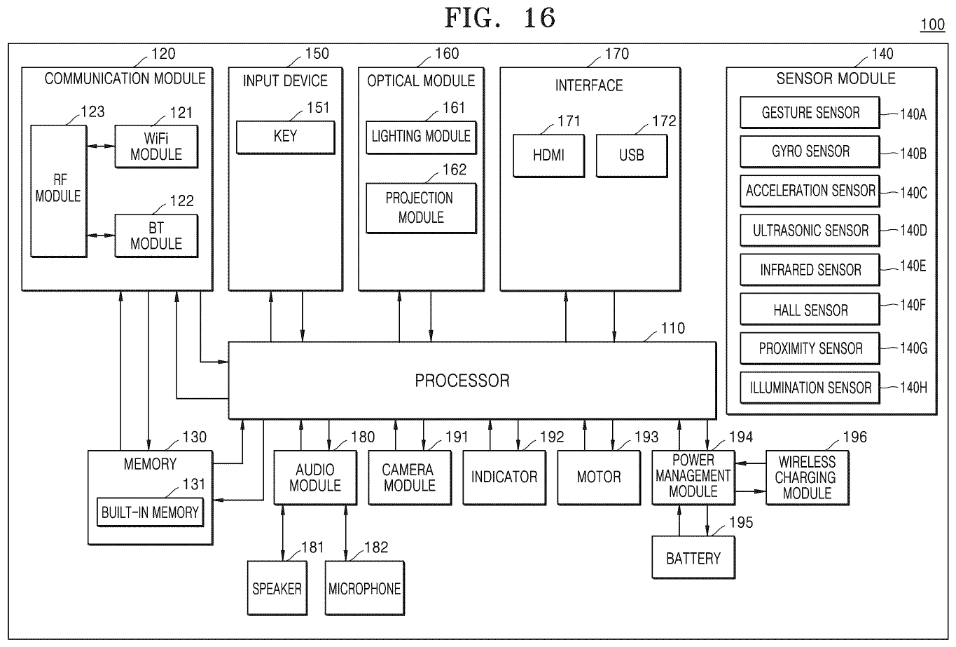

Referring to FIG. 14, the processor 1400 of FIG. 14 may be an example of a processor 110 included in an electronic device 100 illustrated in FIGS. 15 and 16.

The processor 1400 according to an embodiment of the disclosure may include an application module 1410, an input management module 1420, and an input method editor (IME) module 1430. The IME module 1430 may include a touch input mode control module 1440 and a remote input mode control module 1460.

Each element included in the processor 1400 may be a module. In an embodiment of the disclosure, the module may refer to a functional and structural combination of hardware for carrying out the technical concept of the disclosure and software for driving the hardware. For example, the module may refer to a logical unit of certain code and hardware resources for executing the certain code, and does not necessarily refer to physically linked code or is limited to one type of hardware.

In an embodiment of the disclosure, the application module 1410 may activate the input management module 1420 when it is determined that a user's keyboard input is required (for example, when the user selects a search function, etc.). The application module 1410 may include a web browser.

In an embodiment of the disclosure, when the input management module 1420 is activated by the application module 1410, the input management module 1420 may identify whether the touch sensing device 20 is coupled to the electronic device 100.

In an embodiment of the disclosure, the input management module 1420 may identify that the touch sensing device 20 is coupled to the electronic device 100 by sensing a change through a sensor, sensing the flow of a specific electrical signal, or receiving state information or a specific signal from the touch sensing device 20 through wireless communication (e.g., NFC, Bluetooth, etc.).

In an embodiment of the disclosure, when the input management module 1420 identifies whether the touch sensing device 20 is coupled to the electronic device 100, the input management module 1420 may transmit a result of the identifying to the IME module 1430.

In an embodiment of the disclosure, when the result of the identifying received from the input management module 1420 is that the input management module 1420 determines that the touch sensing device 20 is coupled to the electronic device 100, the IME module 1430 may activate the touch input mode control module 1440.

In an embodiment of the disclosure, when the result of the identifying received from the input management module 1420 is that the input management module 1420 determines that the touch sensing device 20 is not coupled to the electronic device 100, the IME module 1430 may activate the remote input mode control module 1460.

In an embodiment of the disclosure, the touch input mode control module 1440 may be activated by the IME module 1430 when the touch sensing device 20 is coupled to the electronic device 100.

In an embodiment of the disclosure, the touch input mode control module 1440 may control the projection module to project the soft keyboard corresponding to the first keyboard layout 310 on the projection plane 40.

In an embodiment of the disclosure, the touch input mode control module 1440 may determine to change the keyboard layout of the soft keyboard from the second keyboard layout 320 to the first keyboard layout 310, and may control the projection module to project the soft keyboard corresponding to the first keyboard layout 310 on the projection plane 40.

In an embodiment of the disclosure, the touch input mode control module 1440 may control the projection module to project the soft keyboard corresponding to the first keyboard layout 310 at the lower end of the layout on which content is being projected. In an embodiment of the disclosure, the touch input mode control module 1440 may control the projection module to stop projecting content and project the soft keyboard corresponding to the first keyboard layout 310.

In an embodiment of the disclosure, the touch input mode control module 1440 may include a soft keyboard layout optimization module 1450.

In an embodiment of the disclosure, the soft keyboard layout optimization module 1450 may obtain a variety of information about the user's touch input (e.g., touch position information, touch count information, etc.) on the soft keyboard corresponding to the projected first keyboard layout 310 from the touch sensing device 20 through data pins or wireless communication technology (e.g., NFC, Bluetooth, etc.).

In an embodiment of the disclosure, the soft keyboard layout optimization module 1450 may detect an error of the user's touch input based on the obtained information about the touch position of the user and the obtained information about the touch count of the user. In order to compensate for the detected error of the user's touch input, the soft keyboard layout optimization module 1450 may adjust at least one of the size, the spacing, or the position of soft keys included in the soft keyboard corresponding to the first keyboard layout 310.

In an embodiment of the disclosure, the soft keyboard layout optimization module 1450 may receive, from the camera sensor 50, image data of a user's touch input situation.

In an embodiment of the disclosure, the soft keyboard layout optimization module 1450 may obtain information related to the user's hands by analyzing the received image data. In an embodiment of the disclosure, the information related to the user's hands may include at least one of the number of the user's hands, the position and direction of the user's hands, whether the user's hand is a left hand or a right hand, the spacing between the user's hands, or the length of the finger included in the user's hand.

In an embodiment of the disclosure, the soft keyboard layout optimization module 1450 may determine the type of soft keyboard corresponding to the first keyboard layout 310 based on the obtained information related to the user's hands, and may adjust the size, the spacing, or the position of soft keys included in the soft keyboard corresponding to the first keyboard layout 310.

In an embodiment of the disclosure, the remote input mode control module 1460 may be activated by the IME module 1430 when the touch sensing device 20 is not coupled to the electronic device 100.

In an embodiment of the disclosure, the remote input mode control module 1460 may control the projection module to project the soft keyboard corresponding to the second keyboard layout 320 on the projection plane 40.

In an embodiment of the disclosure, the remote input mode control module 1460 may determine to change the keyboard layout of the soft keyboard from the first keyboard layout 310 to the second keyboard layout 320, and may control the projection module to project the soft keyboard corresponding to the second keyboard layout 320 on the projection plane 40.

In an embodiment of the disclosure, the remote input mode control module 1460 may control the projection module to project the soft keyboard corresponding to the second keyboard layout 320 at the lower end of the layout on which content is being projected. In an embodiment of the disclosure, the remote input mode control module 1460 may control the projection module to stop projecting content and project the soft keyboard corresponding to the second keyboard layout 320.

According to an embodiment of the disclosure, the processor 1400 may allow the user to perform input more efficiently and conveniently by providing a method of dynamically configuring a soft keyboard layout most effective for a user according to a user's input method.

On the other hand, the block diagram of the processor 1400 illustrated in FIG. 14 is a block diagram for an embodiment of the disclosure. Each element of the block diagram may be integrated, added, or omitted according to the specifications of the processor 1400 that is actually implemented. For example, when necessary, two or more elements may be integrated into one element, or one element may be subdivided into two or more elements. In addition, the functions performed by each block are for describing the embodiments of the disclosure, and specific operations or devices thereof are not intended to limit the scope of the disclosure.

FIG. 15 is a block diagram of an electronic device 100 according to an embodiment of the disclosure.

Referring to FIG. 15, the electronic device 100 according to an embodiment of the disclosure may include a projection module 162, memory 130, and at least one processor 110. However, the electronic device 100 may be implemented with more elements than those illustrated in FIG. 15, and the disclosure is not limited to the examples described above. The elements are sequentially described below.

The projection module 162 may project a graphic image on a projection plane under the control of the at least one processor 110. The projection module 162 may also be referred to as an optical module. The projection module 162 may also be referred to as ‘projection component’ as a device element.

The memory 130 may store programs for processing and control by the at least one processor 110 and may store data input to or output from the electronic device 100.

The memory 130 may include at least one type of storage medium selected from flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc.

The memory 130 according to an embodiment of the disclosure may include one or more instructions that execute a function of dynamically configuring a soft keyboard layout most effective to a user, which is disclosed in the disclosure.

The at least one processor 110 may control overall operations of the electronic device 100. For example, the at least one processor 110 may execute the one or more instructions stored in the memory 130 to control the projection module 162 and perform the functions of the electronic device 100 described with reference to FIGS. 1 to 14.

The processor 110 may be implemented as one or more processors. At this time, the one or more processors may be a general-purpose processor, such as a central processing unit (CPU), an application processor (AP), or a digital signal processor (DSP), a dedicated graphics processor, such as a graphics processing unit (GPU) or a vision processing unit (VPU), or a dedicated artificial intelligence processor, such as a neural processing unit (NPU). For example, when the one or more processors are dedicated artificial intelligence processors, the dedicated artificial intelligence processors may be designed with a hardware structure specialized for processing a specific artificial intelligence model.

The processor (110) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor (110) may include a combination of processors performing various of the recited/disclosed functions, e.g., in a distributed manner. At least one processor (110) may execute program instructions to achieve or perform various functions.

According to an embodiment of the disclosure, the at least one processor 110 may identify whether the touch sensing device is coupled to the electronic device so as to detect the user's touch input on the soft keyboard. The touch sensing device is configured to detachably couple to the electronic device, When the at least one processor 110 identifies that the touch sensing device is coupled to the electronic device, the at least one processor 110 may control the projection component to project the soft keyboard corresponding to the first keyboard layout on the projection plane.

According to an embodiment of the disclosure, as the at least one processor 110 identifies that the touch sensing device is not coupled to the electronic device, the at least one processor 110 may control the projection component to project the soft keyboard corresponding to the second keyboard layout on the projection plane.

According to an embodiment of the disclosure, as the at least one processor 110 identifies that the touch sensing device is coupled to the electronic device while projecting the soft keyboard corresponding to the second keyboard layout, the at least one processor 110 may control the projection component to change the soft keyboard corresponding to the second keyboard layout to the soft key keyboard corresponding to the first keyboard layout and project the changed soft keyboard.

According to an embodiment of the disclosure, as the at least one processor 110 identifies that the touch sensing device is separated from the electronic device while projecting the soft keyboard corresponding to the first keyboard layout, the at least one processor 110 may control the projection component to change the soft keyboard corresponding to the first keyboard layout to the soft key keyboard corresponding to the second keyboard layout and project the changed soft keyboard.

According to an embodiment of the disclosure, the first keyboard layout may be a keyboard layout corresponding to the touch input mode, and the second keyboard layout may be a keyboard layout corresponding to the remote input mode.

According to an embodiment of the disclosure, the at least one processor 110 may identify that the projection mode of the electronic device to which the touch sensing device is coupled is switched from the floor projection mode to the wall projection mode. Based on identification that the projection mode of the electronic device to which the touch sensing device is coupled is switched to the wall projection mode, the at least one processor 110 may control the projection component to change the soft keyboard corresponding to the first keyboard layout to the soft keyboard corresponding to the second keyboard layout and project the changed soft keyboard.

According to an embodiment of the disclosure, the at least one processor 110 may identify that the projection mode of the electronic device to which the touch sensing device is coupled is switched from the floor projection mode to the wall projection mode. Based on identification that the projection mode of the electronic device to which the touch sensing device is coupled is switched to the wall projection mode, the at least one processor 110 may disable the touch input mode. The at least one processor 110 may control the projection component to project, on the projection plane, a UI that guides an adjustment of the projection direction or the position of the electronic device to correspond to the wall projection mode or the floor projection mode.

According to an embodiment of the disclosure, the at least one processor 110 may detect an error of the touch input of the user based on information collected by the touch sensing device coupled to the electronic device. In order to compensate for the detected error of the touch input of the user, the at least one processor 110 may adjust at least one of the size, the spacing, or the position of soft keys included in the soft keyboard corresponding to the first keyboard layout.

According to an embodiment of the disclosure, the at least one processor 110 may obtain image data capturing a touch input activity of the user. The at least one processor 110 may obtain information related to a hands of the user by analyzing the image data. In an embodiment of the disclosure, the information related to the hands of the user may include at least one of the number of the hands of the user, the position and direction of the hands of the user, whether the hand of the user is a left hand or a right hand, the spacing between the hands of the user, or the length of the finger included in the hand of the user. The at least one processor 110 may determine the type of soft keyboard corresponding to the first keyboard layout based on the obtained information related to the hands of the user, and may adjust the size, the spacing, or the position of soft keys included in the soft keyboard corresponding to the first keyboard layout.

According to an embodiment of the disclosure, based on the hands of the user being identified by analyzing the image data, the at least one processor 110 may control the projection component to project the soft keyboard corresponding to the first keyboard layout. Based on the hands of the user not being identified by analyzing the image data, the at least one processor 110 may control the projection component to project the soft keyboard corresponding to the second keyboard layout or not to project the soft keyboard.

According to an embodiment of the disclosure, the electronic device 100 may allow the user to perform input more efficiently and conveniently by providing a method of dynamically configuring a soft keyboard layout most effective for a user according to a user's input method.

However, effects to be achieved by the disclosure are not limited to those described above, and other effects that are not mentioned herein will be clearly understood from the following description by those of ordinary skill in the art.

FIG. 16 is a detailed block diagram of an electronic device 100 according to an embodiment of the disclosure.

Referring to FIG. 16, the electronic device 100 may, for example, constitute all or part of the electronic device 100 illustrated in FIG. 15. The electronic device 100 may include at least one processor 110, a communication module 120, memory 130, a sensor module 140, an input device 150, an optical module 160, an interface 170, an audio module 180, a camera module 191, an indicator 192, a motor 193, a power management module 194, a battery 195, and a wireless charging module 196.

The at least one processor 110 may drive an operating system or an application program to control a plurality of hardware or software elements connected to the processor 110 and may perform a variety of data processing and computations, including multimedia data. The processor 110 may be implemented as, for example, a system on chip (SoC). The processor 110 may further include a GPU (not shown).

The communication module 120 may transmit and receive data in communication between the electronic device 100 and other electronic devices connected through a network, for example, peripheral devices or a server. According to an embodiment of the disclosure, the communication module 120 may include a wireless fidelity (Wi-Fi) module 121, a Bluetooth (BT) module 122, and a radio frequency (RF) module 123.

Each of the Wi-Fi module 121 and the BT module 122 may include, for example, a processor that processes data transmitted and received through the corresponding module. In FIG. 4, the Wi-Fi module 121 and the BT module 122 are illustrated as separate blocks. However, according to an embodiment of the disclosure, at least a portion of the Wi-Fi module 121 or the BT module 122 may be included in a single integrated chip (IC) or an IC package. For example, at least some of the processors corresponding to the Wi-Fi module 121 and the BT module 122 may be implemented as a single SoC.

The RF module 123 may transmit and receive data, for example, an RF signal. The RF module 123 may include, for example, a transceiver (not shown), a power amp module (PAM), a frequency filter, or a low noise amplifier (LNA). In addition, the RF module 123 may further include components, for example, conductors or electric wires, which transmit and receive electromagnetic waves in free space in wireless communication. In FIG. 4, the Wi-Fi module 121 and the BT module 122 are illustrated as sharing one RF module 123. However, according to an embodiment of the disclosure, at least one of the Wi-Fi module 121 or the BT module 122 may transmit and receive the RF signal through separate RF modules.

The memory 130 may include built-in memory 131. The built-in memory 131 may include, for example, at least one of volatile memory (e.g., dynamic random access memory (RAM) (DRAM), static RAM (SRAM), synchronous DRAM (SDRAM), etc.) or non-volatile memory (e.g., one time programmable read-only memory (ROM) (OTPROM), programmable ROM (PROM), erasable and programmable ROM (EPROM), electrically erasable and programmable ROM (EEPROM), mask ROM, flash ROM, NAND flash memory, NOR flash memory, etc.).

The memory 130 may store a variety of data, programs, or applications that drive and control the electronic device 100 under the control of the processor 110. The memory 130 may store input/output signals or data corresponding to the driving of the at least one processor 110, the communication module 120, the sensor module 140, the input device 150, the optical module 160, the interface 170, the audio module 180, the camera module 191, the indicator 192, the motor 193, the power management module 194, the battery 195, and the wireless charging module 196.

The sensor module 140 may measure physical quantity or sense the operating state of the electronic device 100 and may convert the measured or sensed information into electrical signals. The sensor module 140 may include, for example, at least one of a gesture sensor 140A, a gyro sensor 140B, an acceleration sensor 140C, an ultrasonic sensor 140D, an infrared sensor 140E, a hall sensor 140F, a proximity sensor 140G, or an illumination sensor 140H. Additionally or alternatively, the sensor module 140 may include, for example, a space sensor (not shown), an E-nose sensor (not shown), an electromyography (EMG) sensor (not shown), an electroencephalogram (EEG) sensor (not shown), an electrocardiogram (ECG) sensor (not shown), an iris sensor, a fingerprint sensor, or a pressure sensor. The sensor module 140 may further include control circuitry that controls at least one sensor included therein.

The input device 150 may include a key 151. The key 151 may include, for example, a physical button, an optical key, or a keypad. According to an embodiment of the disclosure, the electronic device 100 may receive user input from an external device connected thereto by using the communication module 120.

The optical module 160 may include a lighting module 161 and a projection module 162. The projection module 163 may display an image by projecting light onto a screen.

The projection module 162 may project light in digital light processing (DLP), liquid crystal on silicon (LCOS), 3-liquid crystal display (3LCD), LCD, or laser method.

The DLP is a projection display method that uses a digital micromirror display (DMD), which is one of the display elements. The LCOS method may define pixels by a plurality of scan lines and a plurality of data lines, may include liquid crystals with a certain molecular arrangement, and may project light by using an LCOS panel that transmits, reflects, and display light input from the outside by the liquid crystals. In the 3LCD method, the LCD through which a lamp light source of a projector is transmitted may be divided into three parts. The 3LCD may use red, blue, and green 3LCDs where light from the lamp is divided into colors before being magnified by the lens through the LCD panel. A projector may be implemented by the 3LCD method as described above. In addition, like the LCD, a projector using a single LCD panel may also be provided. The laser method may include a light source including red, green, and blue laser light emitting elements, an optical tunnel into which laser light emitted from the light source is incident, and a display element that projects an image onto a screen by using the laser light incident through the optical tunnel. Inside the optical tunnel, a structure including a synthesis module that synthesizes some colors of the laser light emitted from the light source by transmitting or reflecting the colors of the laser light and a speckle remover that removes speckles by irregularly converting the phase of the laser light synthesized through the synthesis module may be provided as a projection module.

The interface 170 may include, for example, a high-definition multimedia interface (HDMI) 171 and a USB 172. The interface 170 may be included in, for example, the communication module 120. Additionally or alternatively, the interface 170 may include, for example, a mobile high-definition link (MHL) interface, a SD card/multi-media card (MMC) interface, or an infrared data association (IrDA) standard interface.

The audio module 180 may bidirectionally convert sound and electrical signals. The audio module 180 may process sound information that is input or output through, for example, a speaker 181 or a microphone 182. According to an embodiment of the disclosure, the electronic device 100 may not include the audio module 180 and may transmit audio to an external device by using the BT module 122 included in the communication module 120.

The camera module 191 is a device capable of capturing still images and moving images. According to an embodiment of the disclosure, the camera module 191 may include one or more image sensors (e.g., a front sensor or a rear sensor), a lens (not shown), an image signal processor (ISP) (not shown), or a flash (not shown) (e.g., an LED or a xenon lamp).

The camera module 191 may receive images (e.g., consecutive frames) corresponding to a user's motion, including gestures, within a camera recognition range. For example, the recognition range of the camera module 191 may be within 0.1 m to 5 m from the camera module 191 to the user. The user's motion may include, for example, a user's face, facial expression, a part of a user's body, such as a hand, a fist, or a finger, or a motion of a part of the user.

The indicator 192 may display a specific state of the electronic device 100 or a portion thereof (e.g., the processor 110), for example, a booting state, a message state, or a charging state.

The motor 193 may convert electrical signals into mechanical vibration. Although not illustrated, the electronic device 100 may include a processing device (e.g., a GPU) capable of supporting mobile TV. The processing device capable of supporting mobile TV may process, for example, media data according to standards, such as digital multimedia broadcasting (DMB), digital video broadcasting (DVB), or media flow.

The power management module 194 may manage the power of the electronic device 100. Although not illustrated, the power management module 194 may include, for example, a power management integrated circuit (PMIC), a charger IC, or a battery or fuel gauge.

When the electronic device 100 is located on the project plane or approaches within a certain distance from the projection plane, the power management module 194 may apply power to the optical module 160 so as to cause the optical module 160 to operate.

When the electronic device 100 does not approach within a certain distance from the projection plane, the power management module 194 may cut off power to the optical module 160 so as to prevent the optical module 160 from operating.

The PMIC may be mounted, for example, within an IC or a SoC semiconductor. Charging methods may be divided into wired charging methods and wireless charging methods. An charger IC may charge the battery and prevent overvoltage or overcurrent from being introduced from a charger. According to an embodiment of the disclosure, the charger IC may perform at least one of a wired charging method or a wireless charging method.

The wireless charging module 196 may include circuitry capable of wireless charging, for example, a coil loop, resonance circuitry, or a rectifier, and the wireless charging method may include, for example, a magnetic resonance method, a magnetic induction method, or an electromagnetic wave method.

The battery gauge may measure, for example, the remaining capacity of the battery 195 and the voltage, current, or temperature during charging. The battery 195 may store or generate electricity and supply power to the electronic device 100 by using the stored or generated electricity. The battery 195 may include, for example, a rechargeable battery or a solar battery.

Each of the above-described elements of the electronic device 100 according to an embodiment of the disclosure may include one or more components, and the names of the corresponding elements may vary depending on the type of electronic device. The electronic device 100 according to an embodiment of the disclosure may be configured to include at least one of the above-described elements. Some elements may be omitted or other additional elements may be further included. In addition, some of the elements of the electronic device 100 according to an embodiment of the disclosure may be combined to constitute a single entity, and thus, the same functions as those of the elements before being combined may be performed.

A specific example for describing the embodiment of the disclosure is only a combination of each standard, method, detailed method, and operation. Through a combination of at least two of the various techniques described above, the electronic device 100 may allow the user to perform input more efficiently and conveniently by providing a method of dynamically configuring a soft keyboard layout most effective for the user according to the user's input method. In addition, this may be performed according to a method determined through one or a combination of at least two of the techniques described above. For example, some operations of an embodiment of the disclosure may be performed in combination with some operations of an embodiment of the disclosure.

A machine-readable storage medium may be provided in the form of a non-transitory storage medium. The “non-transitory storage medium” is a tangible device and only means not including a signal (e.g., electromagnetic waves). This term does not distinguish between a case where data is semi-permanently stored in a storage medium and a case where data is temporarily stored in a storage medium. For example, the non-transitory storage medium may include a buffer in which data is temporarily stored.

According to an embodiment of the disclosure, the methods according to various embodiments of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

According to an embodiment of the disclosure, the electronic device may allow the user to perform input more efficiently and conveniently by providing a method of dynamically configuring a soft keyboard layout most effective for a user according to a user's input method when projecting content. However, effects to be achieved by the disclosure are not limited to those described above, and other effects that are not mentioned herein will be clearly understood from other descriptions by those of ordinary skill in the art.

What is claimed is:

1. An electronic device comprising:
a projection component;
at least one processor including processing circuitry; and
memory storing one or more instructions that, when executed by the at least one processor individually or collectively, cause the electronic device to:
identify whether a touch sensing device is coupled to the electronic device to sense a touch input of a user on a soft keyboard, wherein the touch sensing device is configured to detachably couple to the electronic device; and
based on identification that the touch sensing device is coupled to the electronic device, control the projection component to project a soft keyboard corresponding to a first keyboard layout on a projection plane.

2. The electronic device of claim 1, wherein the memory stores the one or more instructions that, when executed by the at least one processor individually or collectively, cause the electronic device further to:
based on identification that the touch sensing device is not coupled to the electronic device, control the projection component to project a soft keyboard corresponding to a second keyboard layout on the projection plane.

3. The electronic device of claim 2, wherein the memory stores the one or more instructions that, when executed by the at least one processor individually or collectively, cause the electronic device further to:
based on identification that the touch sensing device is coupled to the electronic device while projecting the soft keyboard corresponding to the second keyboard layout, control the projection component to change the soft keyboard corresponding to the second keyboard layout to the soft keyboard corresponding to the first keyboard layout and project the soft keyboard corresponding to the first keyboard layout.

4. The electronic device of claim 2, wherein the memory stores the one or more instructions that, when executed by the at least one processor individually or collectively, cause the electronic device further to:
based on identification that the touch sensing device is separated from the electronic device while projecting the soft keyboard corresponding to the first keyboard layout, control the projection component to change the soft keyboard corresponding to the first keyboard layout to the soft keyboard corresponding to the second keyboard layout and project the soft keyboard corresponding to the second keyboard layout.

5. The electronic device of claim 2, wherein the first keyboard layout is a keyboard layout corresponding to a touch input mode and the second keyboard layout is a keyboard layout corresponding to a remote input mode.

6. The electronic device of claim 2, wherein the memory stores the one or more instructions that, when executed by the at least one processor individually or collectively, cause the electronic device further to:
identify that a projection mode of the electronic device to which the touch sensing device is coupled is switched from a floor projection mode to a wall projection mode; and
based on identification that the projection mode of the electronic device to which the touch sensing device is coupled is switched to the wall projection mode, control the projection component to change the soft keyboard corresponding to the first keyboard layout to the soft keyboard corresponding to the second keyboard layout and project the soft keyboard corresponding to the second keyboard layout.

7. The electronic device of claim 1, wherein the memory stores the one or more instructions that, when executed by the at least one processor individually or collectively, cause the electronic device further to:
identify that a projection mode of the electronic device to which the touch sensing device is coupled is switched from a floor projection mode to a wall projection mode;
based on identification that the projection mode of the electronic device to which the touch sensing device is coupled is switched to the wall projection mode,
disable a touch input mode; and
control the projection component to project, on the projection plane, a user interface (UI), wherein the UI guides an adjustment of a projection direction or a position of the electronic device to correspond to the wall projection mode or the floor projection mode.

8. The electronic device of claim 1, wherein the memory stores the one or more instructions that, when executed by the at least one processor individually or collectively, cause the electronic device further to:
based on information collected by the touch sensing device coupled to the electronic device, detect an error of the touch input of the user; and
adjust at least one of a size, a spacing, or a position of soft keys included in the soft keyboard corresponding to the first keyboard layout so as to compensate for the detected error of the touch input of the user.

9. The electronic device of claim 1, wherein the memory stores the one or more instructions that, when executed by the at least one processor individually or collectively, cause the electronic device further to:
obtain image data capturing a touch input activity of the user
obtain information related to a hand of the user by analyzing the image data, wherein the information related to the hand of the user includes at least one of: a number of hands of the user, a position and a direction of the hands of the user, whether the hand of the user is a left hand or a right hand, a spacing between two hands of the user, or a length of a finger included in the hand of the user; and
based on the obtained information related to the hand of the user, determine a type of the soft keyboard corresponding to the first keyboard layout; and adjust a size, a spacing, or a position of the soft keys included in the soft keyboard corresponding to the first keyboard layout.

10. The electronic device of claim 9, wherein the memory stores the one or more instructions that, when executed by the at least one processor individually or collectively, cause the electronic device further to:
based on the hand of the user being identified by analyzing the image data, control the projection component to project the soft keyboard corresponding to the first keyboard layout; and
based on the hand of the user not being identified by analyzing the image data, control the projection component to project the soft keyboard corresponding to the second keyboard layout or not to project the soft keyboard.

11. An operating method of an electronic device, the operating method comprising:
identifying whether a touch sensing device is coupled to the electronic device so as to sense a touch input of a user on a soft keyboard, wherein the touch sensing device is configured to detachably couple to the electronic device; and
based on identification that the touch sensing device is coupled to the electronic device, controlling, a projection component to project a soft keyboard corresponding to a first keyboard layout on a projection plane.

12. The operating method of claim 11, further comprising:
based on identification that the touch sensing device is not coupled to the electronic device, controlling the projection component to project a soft keyboard corresponding to a second keyboard layout on the projection plane.

13. The operating method of claim 12, further comprising:
based on identification that the touch sensing device is coupled to the electronic device while projecting the soft keyboard corresponding to the second keyboard layout, controlling the projection component to change the soft keyboard corresponding to the second keyboard layout to the soft keyboard corresponding to the first keyboard layout and project the soft keyboard corresponding to the first keyboard layout.

14. The operating method of claim 12, further comprising:
based on identification that the touch sensing device is separated from the electronic device while projecting the soft keyboard corresponding to the first keyboard layout, controlling the projection component to change the soft keyboard corresponding to the first keyboard layout to the soft keyboard corresponding to the second keyboard layout and project the soft keyboard corresponding to the second keyboard layout.

15. The operating method of claim 12, wherein the first keyboard layout is a keyboard layout corresponding to a touch input mode and the second keyboard layout is a keyboard layout corresponding to a remote input mode.

16. The operating method of claim 12, further comprising:
identifying that the projection mode of the electronic device to which the touch sensing device is coupled is switched from a floor projection mode to a wall projection mode; and
based on identification that the projection mode of the electronic device to which the touch sensing device is coupled is switched to the wall projection mode, controlling the projection component to change the soft keyboard corresponding to the first keyboard layout to the soft keyboard corresponding to the second keyboard layout and project the soft keyboard corresponding to the second keyboard layout.

17. The operating method of claim 11, further comprising:
identifying that the projection mode of the electronic device to which the touch sensing device is coupled is switched from a floor projection mode to a wall projection mode;
based on identification that the projection mode of the electronic device to which the touch sensing device is coupled is switched to the wall projection mode, disabling a touch input mode; and
controlling the projection component to project, on the projection plane, a user interface (UI), wherein the UI guides an adjustment of a projection direction or a position of the electronic device to correspond to the wall projection mode or the floor projection mode.

18. The operating method of claim 11, further comprising:
based on information collected by the touch sensing device coupled to the electronic device, detecting an error of the touch input of the user; and
adjusting at least one of a size, a spacing, or a position of soft keys included in the soft keyboard corresponding to the first keyboard layout so as to compensate for the detected error of the touch input of the user.

19. The operating method of claim 11, further comprising:
obtaining image data capturing a touch input activity of the user;
obtaining information related to a hand of the user by analyzing the image data, wherein the information related to the hand of the user includes at least one of a number of hands of the user, a position and a direction of the hands of the user, whether the hand of the user is a left hand or a right hand, a spacing between two hands of the user, or a length of a finger included in the hand of the user;
based on the obtained information related to the hand of the user, determining a type of the soft keyboard corresponding to the first keyboard layout; and
adjusting a size, a spacing, or a position of the soft keys included in the soft keyboard corresponding to the first keyboard layout.

20. A non-transitory computer-readable recording medium having recorded thereon at least one program for causing a computer to implement an operating method comprising:
identifying, whether a touch sensing device is coupled to the electronic device so as to sense a touch input of a user on a soft keyboard, wherein the touch sensing device is configured to detachably couple to the electronic device; and
based on identification that the touch sensing device is coupled to the electronic device, controlling, a projection component to project a soft keyboard corresponding to a first keyboard layout on a projection plane.
